(19) United States
(12) Patent Application Publication
(10) Pub. No.: US 2004/0064480 A1
(43) Pub. Date: Apr. 1, 2004

(54) System and method for utilizing profile information

(76) Inventors: Troy L. Bartlett, Dacula, GA (US); Bernard K. Henry, Alpharetta, GA (US); Said Mohammadioun, Atlanta, GA (US); David McDonald, Acworth, GA (US); William H. Jones, Atlanta, GA (US); Bret A. Johnson, Alpharetta, GA (US)

Correspondence Address: Robert E. Stachler II, c/o Smith, Gambrell & Russell, LLP, Suite 800, 1850 M Street, N.W., Washington, DC, 20036, US

(21) Appl. No.: 10/622,364

(22) Filed: Jul. 18, 2003

Related U.S. Application Data
(60) Provisional application No. 60/397,049, filed on Jul. 19, 2002.

(51) Int. Cl. G06F 7/00

(52) U.S. Cl. 707/104.1

(57) ABSTRACT

The present invention provides a system and method for utilizing profile information to set and maintain general and applications settings. In architecture, the system includes a computer device for performing the operation. The computer device comprises an operation module that determines an operation type and a setting module that determines the set of setting to perform the operation on the computer device. Moreover, the computer device further comprises an acquisition module that acquires the set of setting to perform the operation on the computer device. The present invention can also be viewed as a method for utilizing profile information to set and maintain general and applications settings. The method operates by (1) determining the operation on the computer device; (2) determining the set of setting to perform the operation on the computer device; and (3) acquiring the set of setting to perform the operation on the computer device.

### CROSS-REFERENCE TO RELATED APPLICATIONS

This application claims the benefit of U.S. Patent Application Serial No. 60/397,049, filed on Jul. 19, 2002, entitled “EMAIL ACCELERATOR PRODUCT—SERVICE BUREAU SUPPORT”, which is incorporated by reference herein in its entirety.

### FIELD OF THE INVENTION

The present invention relates to a method and system for maintaining computer operations, and more particularly, relates to a method and system for utilizing profile information to set and maintain general and applications settings.

### BACKGROUND OF THE INVENTION

In many business environments, a server is used to store data that is pertinent to many employees or remote users of a business. The server is typically accessible by remote computer devices (“clients”) to increase the availability of information to the remote users. By providing files on a server, which may be accessed by remote computer devices, dissemination of information through the company is increased. Remote access to data is more critical in environments where a sales force or many employees operate away from the office. As an example, the remote employees rely on the information to be up-to-date to be informed about inventory changes, pricing data, and company events.

An issue for this type of computer environment is the setting and maintaining of general and applications settings. Currently, users must have their computer and application settings captured and maintained individually. This can put an extreme burden on not just the user, but the administrator for the server and applications.

Another issue is that users may not know what the best choice of settings for their particular situation. The variety of applications and different connection types can lead to a large variety of the different scenarios that may require different settings. Thus, maximizing the efficiency of the connection and or application is almost impossible for all except the most sophisticated of computer users.

Still another issue is that company administrators do not have any control over any of the user settings when the user has to maintain all the settings. Settings that may be a burden include, but are not limited to, the size of email synchronized, security, encryption settings, device that users are allowed to use, which mail server supports the user and the like.

Thus, heretofore an unaddressed need exists in the industry to address the aforementioned deficiencies quickly and efficiently.

### SUMMARY OF THE INVENTION

The invention provides a system and method for utilizing profile information to set and maintain general and applications settings. The invention may be conceptualized a computer device for performing the operation. The computer device comprises an operation module that determines an operation type and a setting module that determines the set of setting to perform the operation on the computer device. Moreover, the computer device further comprises an acquisition module that acquires the set of setting to perform the operation on the computer device.

The invention may also be conceptualized as a method utilizing profile information to set and maintain general and applications settings, the method comprising the steps of: (1) determining the operation on the computer device; (2) determining the set of setting to perform the operation on the computer device; and (3) acquiring the set of setting to perform the operation on the computer device.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of the network environment for a server computer system and the remote devices utilizing the profile system of the present invention.

FIG. 2A is a block diagram illustrating an example of a server utilizing the profile system of the present invention, as shown in FIG. 1.

FIG. 2B is a block diagram illustrating an example of a remote device utilizing the profile system of the present invention, as shown in FIG. 1.

FIG. 2C is a diagram illustrating an example of a user interface for inputting the example Inbox profile settings for the example Power Users group that can be utilized by the profile system of the present invention, as shown in FIG. 1.

FIG. 2D is a diagram illustrating an example of a user interface for inputting the example profile settings for the example Marketing group that can be utilized by the profile system of the present invention, as shown in FIG. 1.

FIG. 2E is a diagram illustrating an example of a user interface for inputting the example profile settings for the example individual user Suzy Que that can be utilized by the profile system of the present invention, as shown in FIG. 1.

FIG. 3 is a flow chart illustrating an example of the operation of the profile system of the present invention on the server, as shown in FIGS. 1 and 2A.

FIG. 4 is a flow chart illustrating an example of the operation of the admin create process utilized by the profile system of the present invention, as shown in FIGS. 1-3.

FIG. 5 is a flow chart illustrating an example of the operation of the import process utilized by the profile system of the present invention, as shown in FIGS. 2A-3.

FIG. 6 is a flow chart illustrating an example of the operation of the user import process utilized by the profile system of the present invention, as shown in FIGS. 2A-3.

FIG. 7 is a flow chart illustrating an example of the operation of the group import process utilized by the profile system of the present invention, as shown in FIGS. 2A-3.

FIG. 8 is a flow chart illustrating an example of the operation of the user sign-up process utilized by the profile system of the present invention, as shown in FIGS. 2A-3.

FIG. 9 is a flow chart illustrating an example of the operation of the user sync discover process utilized by the profile system of the present invention, as shown in FIGS. 2A-3.

FIG. 10 is a flow chart illustrating an example of the operation of the define profile process utilized by the profile system of the present invention, as shown in FIGS. 2A-3.

FIG. 11 is a flow chart illustrating an example of the operation of the assign profile process utilized by the profile system of the present invention, as shown in FIGS. 2A-3.

FIG. 12 is a flow chart illustrating an example of the operation of the establish priority process utilized by the profile system of the present invention, as shown in FIGS. 2A-3.

FIG. 13 is a flow chart illustrating an example of the process flow of the remote device that utilizes the profile settings of the present invention, as shown in FIGS. 1-12.

FIG. 14A is a flow chart illustrating an example of the operation of the synchronization process that operates on remote device that utilizes the profile system of the present invention, as shown in FIGS. 1-12.

FIG. 14B is a flow chart illustrating an example of the operation of the server synchronization process utilized by the profile system of the present invention, as shown in FIGS. 2A-3.

FIG. 15A is a flow chart illustrating an example of the operation of the client profile exchange process that that utilizes the profile system of the present invention, as shown in FIGS. 1-12.

FIG. 15B is a flow chart illustrating an example of the operation of the server profile exchange process utilized by the profile system of the present invention, as shown in FIGS. 2A-3.

FIG. 16 is a flow chart illustrating an example of the operation of the editing client settings process that that utilizes the profile system of the present invention, as shown in FIGS. 1-12.

FIG. 17 is a flow chart illustrating an example of the operation of the using client settings process that that utilizes the profile system of the present invention, as shown in FIGS. 1-12.

### DETAILED DESCRIPTION OF THE INVENTION

The invention to be described hereafter is applicable to all computer processing systems utilizing profile information to set and maintain general and applications settings. While described below with respect to a single computer, the system and method for a remote device data synchronization system is typically implemented in a networked computing arrangement in which a number of computing devices communicate over a local area network (LAN), over a wide area network (WAN), or over a combination of both LAN and WAN.

Profiles system of the present invention gives administrators a logical method of grouping general and application settings so that they can be assigned to groups. This is a complex matrix of settings and assignments. The profiles system of the present invention accomplishes three primary goals: (1) Creates a user interface for the administrator that is straightforward and one that will simplify the task for the administrator to create groups of settings (i.e. set of settings) that can be assigned to users/groups and extend the interface to the users where it is appropriate for users to override; (2) Creates a framework that can be used easily by the rest of the applications and (3) Provide the ability for the administrator to mandate specific settings, or simply set default characteristics of the activities of synchronization, and set only the settings that apply to those users or groups. A set of settings is synonymous with a profile.

Characteristics of the profiles system of the present invention include, but are not limited to:

The application settings are applicable for all applications.

Set of settings (i.e. profiles) can be configured for the default system.

Set of settings are the resolution of the collection of application settings for a given environment, where the environment includes, but is not limited to: user, group, system characteristics, time of day, corporate policy or resource availability.

Application settings are assigned to users, groups-distribution lists and/or organization units.

The administrator can set individual settings for any application as capable of being overwritten or visible.

A set of settings also may apply to user, distribution lists, organizational units or any way of grouping users that are not part of these application settings. An example would be the mailbox name for a specific user.

Application settings include for example, but are not limited to: email, billing information, Personal Information Manager (PIM), personalized info, file delivery, systems management, software updates, websites, file backup, data sync applications, bandwidth management, authentication, Push Sync, ReadySync and the like. For each application (i.e. ‘Email, PIM, Personalized Info Settings, Website Delivery’), a collection of settings are configured and named. “Email Settings”, “PIM Settings”, and “Personalized Info Settings” are all different collections of application settings.

Each category of profiles has a default profile pre-configured at installation. The administrator first may configure these default settings. Next, the administrator may create, set and name application settings that can override these default application settings. The administrator then can subscribe these created application settings to any user, group or distribution list. There is also a programmatic way to add a device or application if necessary. The administrator can optionally add other sets of application settings and assign these settings to particular users/groups that require an override of the default settings.

In general, an administrator sees an Admin Console interface with all the applications for which that customer is licensed. The Admin Console allows the administrator to configure the system including managing users, configuring different applications and managing profiles. Under the profiles menu, the profiles are segmented into a general set of profiles (i.e. a set of a set of settings) and also a set of profiles for each application. Each type of profile is known as a “category”. Under each of the categories is a profile created at installation timed called “Default” which contains settings to be used when no explicit assignment has been performed.

The administrator can create a new profile in a particular category by clicking on a category. They can click on a profile (or set of named settings) like “Power Sales” to modify that profile. Once the individual application settings are defined, they are saved under that named profile. Then, the profile can be assigned to a user or group. The administrator manages the settings for a specific user or group. When the administrator selects the “Properties” for a specific user or group, a dialog box will appear. Each application installed will allow profiles to be applied for the selected user or group. Once the assignments are complete the Administrator is done.

Ideally, the layout of the administrator user interface includes at least some of the following groupings. Administration, users, groups, logs, alerts, reports, file distribution, systems management, mobile data synchronization, e-mail, PIM, profiles, application settings and general settings. The administration user interface would become a global place holder for shared administrator components like logs, alerts, users, groups etc.

This means that users, groups, logs, alerts and reports go under one dialog box. Administrator's may prefer that they be logically grouped something like this for management purposes. Then, if each product has its own logs or alerts etc, they will show in subsequent nodes underneath the parent group that is in the administration tree, not in their individual trees. It is also possible to show profiles as a node in the tree and on one side showing instructions on how to set them up since they may not be named entities and admin needs to click on the user or group to assign them. So to “unhide” them, they are shown on the tree with instructions in HTML or something on one side.

For profiles, they can be in their own dialog box, they need not be listed under each corresponding application. The reason is that an administrator would generally be thinking of profiles from a macro perspective and wouldn't want to go under the Email node and set up email settings then to the systems management node to set up those same settings. This way they are all grouped together. As described above, the profile node will have some sub-nodes underneath it, General Settings, Email+PIM Settings, Systems Management Settings, File Distribution Settings, and Data Synchronization Settings to name just a few possible sub-nodes. Under each sub-node are the different categories of profiles.

One example of an application that utilizes the profiles system of the present invention is the operation of a synchronization event for a remote device. An example remote device data synchronization system would include a repository, such as a central database 12.

The example remote device data synchronization system manages user synchronization sessions, reconciling data changes between the device being synchronized and the repository. Each remote client device uses client software written for that device for synchronizing. The function of the client is to interface with the unique data format of the client device including, but not limited to Palm, OS, MS-Outlook, etc., and to communicate data changes with the remote device data synchronization system. This communication can be performed via HTTP or HTTPS (user selectable), so it is secure and does not impact firewall configuration.

An example profile category is “Inbox settings”. It is typical for synchronization systems to provide control over the amount and type of email that is synchronized between the server's mailbox and the remote devices' email application. Typical settings include control of truncation of the email body by limiting it to a certain number of characters, whether attachments are downloaded, limiting the size of attachments downloaded if allowed, the number of days worth of email to synchronize and the type of attachments as identified by file extension (.doc for Microsoft Word documents, etc.).

Many users may not understand the ramifications of these settings, especially as applied to a low-bandwidth connection (e.g. wide area wireless). It is therefore necessary for the administrator to provide reasonable defaults or perhaps even to disallow changing of certain settings. An administrator could setup a profile for the Inbox category for knowledgeable users called “Power Users” and one called “Novice Users”. The “Power User” profile would allow the user to adjust all settings on the remote device, but default to a 2000 character limit for email body text and no attachments, whereas, the “Novice Users” profile would not allow them to change many of the settings. While restricting the less knowledgeable user's ability may keep them from seeing all of the email they wish, it guarantees that the organization will not incur unreasonable costs because of wireless access bills.

The example remote device data synchronization system also provides illustration of automatic updating of client profile information, if a new version of profile information is available at the time a user synchronizes. A server sends down the new profile information and installs it on remote devices as part of the synchronization process; therefore no intervention is normally required by the user or by the administrator.

In an alternative embodiment, the profile system of the present invention can be used by Mobile Service Bureaus to provide access to numerous services. These services include, but not limited to Exchange and Domino. Mobile Service Bureaus also can provide multiple device type support.

The Mobile Service Bureau can offer the email service to an organization. When signed up, the Mobile Service Bureau will deploy a server to connect to the organization's mail server. This connection generally will occur over a VPN where the mobile server will have an always on secure connection to the organization mail servers. The Mobile Service Bureau will operate under its own domain and connect to the organization domain through the VPN. A successful service bureau needs very few modifications to the organization server implementation.

Mobile Service Bureaus will manage the user lists and the infrastructure to connect to the organization mail servers. Their first benefit, outside of basic features of function, device and server support, is that the solution is minimally intrusive to the organization infrastructure. This definition means that the organization, in order to utilize Mobile Service Bureau's service, should have to configure/allow the VPN connection. All other configurations are made on the Mobile Service Bureau side. This includes domain trusts, user rights, mail configuration and the like.

Mobile Service Bureau will have configured their server machines to utilize a one-way trust from the organization server. This trust has allowed the organization server machine to operate under the Mobile Service Bureau domain, while accessing the mail servers under an organization service administrative account.

When a client is signed up, often they will start with only a few user accounts. The Mobile Service Bureau is understandably reluctant to configure an entire server(s) to support these few user accounts. Over time, given a successful implementation of the early accounts, it is logical to dedicate one or many servers to support this account.

But, in early adoption of the service bureau, a single synchronization server will be able to connect and synchronize from many organization servers. The device owner will connect to the synchronization server over the internet. The synchronization server will then determine the user's account credentials and the user's target organization email server. The user will then be able to continue synchronization.

Given that this is a “outside the organization” solution, security is of utmost importance. The communications should be encrypted, and user credentials should be encrypted. The information store on the server must be minimal. The information stored on the server should be secure. For example, Organization A's users or administrators can in no way view information about Organization B. Organization A's user or administrators can not in any way even know the existence of Organization B on this server.

Information stored on the email server of any sensitivity measure must not be accessible to the Mobile Service Bureau administrator. For example, contacts, schedules or mail must not be accessible by Mobile Service Bureau for any reason; including technical support.

The application for profiles in a Mobile Service Bureau implementation is to determine the mail server for a given user and therefore the organization to which they belong. The Mobile Service Bureau administrator sets up a named profile for each organization under the Microsoft Exchange or Lotus Domino category (depending which type of mail server that organization uses) and assigns the organization's users to their respective profile.

The sequence of events is as follows. When the user connects to the Mobile Service Bureau's server, they are authenticated as an authorized user of the system. They are then verified as an existing user of the system. Their profile information is resolved. Specifically, the profile for the mail server (Microsoft Exchange or Lotus Domino) is resolved and within it is the setting for which mail server to synchronize with and the credentials to use for accessing that mail server. The access method may differ per organization (see below) and certainly the credentials will. This setting is used to access their mailbox. Thus, keeping them securely connected to their organization's mail server while still supporting multiple organizations on a single synchronization server.

As mentioned above, access to the mail server and the credentials used can be done using various methods. The Service Admin account access for Exchange is that a defined Service Administrative user (as defined by Exchange) accesses the mail for a specific user. The Service Administrative user has by Exchange definition full rights to all users' mailboxes. Courier Account access under Domino is a bit different, but the theme's the same. The administrator defines a specific manager level account and for each user who will synchronize, configures their mailbox to provide full access to that mailbox.

Another example regards security and encryption settings. Encryption settings include the type of encryption algorithm used to encrypt and decrypt data sent between the server and remote device (e.g. no encryption, SSL or AES). Security settings include the expiration period for credentials. Here the user could be required to input their authentication credentials on every synchronization or just periodically (perhaps every few hours, few days or never.

One of the applications for this type of profile is in certain organization requirements for access behind their firewall. Many organizations require the use of a VPN connection to gain access behind the firewall, and thus, to the synchronization server. Since the VPN will encrypt the data, it would be redundant for the synchronization software to also encrypt it. For these users, a profile could be created that disabled encryption entirely. For users that only access the synchronization server from inside the firewall, encryption could be enabled using any of those algorithms provided.

Another profile category is client installation and deployment. Using these settings, an administrator could create a profile based on the types of device users were allowed to use. This profile contains settings that define the types of devices the user is allowed to install the remote device software on. The administrator could limit users to installing only on Palm OS, Pocket PC or other supported devices by creating profiles that only contain allowable devices. Thus, limiting the users to devices the organization wants them to use.

Yet another example, is an extension of one discussed previously regarding the profile “Inbox” settings. It is useful for administrators to limit the amount of data sent when synchronizing the Inbox based on which user is synchronizing (based on their ability to manage bandwidth themselves. But it is more realistic for the software to do this for them. For example, an administrator could have a profile that depended on the type of connection the user was using not just which user. A profile for high bandwidth connections might enable synchronization of attachments (perhaps, to a certain size) and not truncate the body text. A profile for low bandwidth connections would still limit the size of body text and not synchronize attachments, perhaps even disabling the user from ever synchronizing attachments for low bandwidth connections.

In another example, profile resolution could depend on the device being used. To further expand the “Inbox” profile example, the administrator could create a profile that limits data that is sent as in any of the examples above and one or more than does not limit or limits to a less degree the amount of data sent. The administrator could then assign one of these profiles to a user's device based on the type of device (Windows CE, Palm OS or Windows PC). The profile limiting data might be assigned to the user's Palm OS device since they generally have less physical storage available for email and other information. The Pocket PC as of this writing has a little more storage available. So the administrator could assign this user a profile with a little less data size constraints than the one assigned to the Palm OS. Finally, the user's PC could be assigned a profile that does not limit the amount of data given that the Windows PC generally contains plenty of storage for most email data.

So we've discussed examples of profiles being used in various situations with several types of settings categories, as well as, shown how they might be applied and resolved in different ways. The simplest being resolution for the user themselves. The next could be speed of the connection being used and finally the type of device the user was using at the time. There are many other characteristics that could be used to resolve the profile. An example would be resolution based on the amount of storage available. This would refine the above example based on devices. There an unlimited number of these variables and characteristics that could be used to resolve profiles for different users and groups and in different situations.

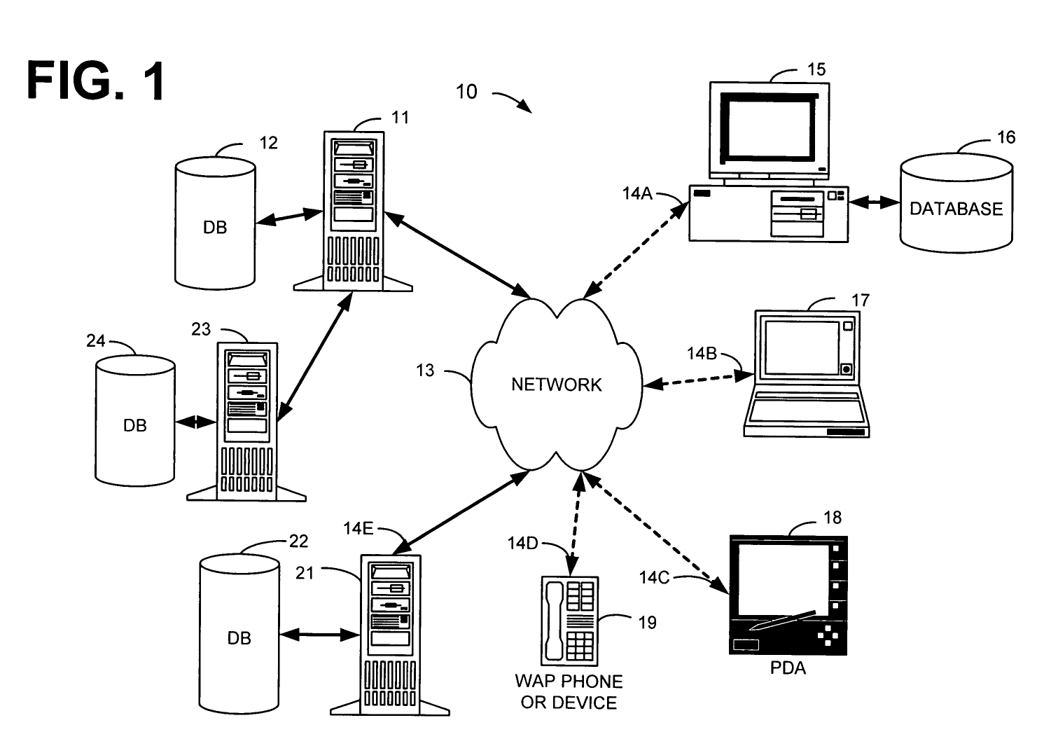

Referring now to the drawings, in which like numerals illustrate like elements throughout the several views, FIG. 1 illustrates the basic components of a system 10 using the profiles system used in connection with the preferred embodiment of the present invention. The system 10 includes remote client systems 15, 17, 18 and 19. Each client has applications and may have a local file or database 16. Computer servers 11, 21 and 23 contain applications, and server 11 further contains a server database 12 that can be accessed by client systems 15, 17, 18 and 19 via intermittent connections 14(a-d), respectively, over network 13. The server 11 runs administrative software for a computer network and controls access to part or all of the network and its devices. The client systems 15, 17, 18 and 19 share the server data stored on the database 12 and may access the server 11 over a network 13, such as but not limited to: the Internet, a local area network (LAN), a wide area network (WAN), via a telephone line using a modem, other like networks or any combination of these networks. The server 11 may also be connected to the local area network (LAN) within an organization. The server 11 may also be connected to other information server or databases, such as for example, but not limited to, mail, database or file servers.

The structure and operation of the profiles system 10 enables the server 11 and the database 12 associated therewith to handle clients more efficiently than previously known systems. Particularly, the profiles system of the present invention provides a manner of organizing the remote device to enable the remote client system to operate more efficiently. In the synchronization example illustrated herein, a modification (“change”, “delta”, or “update”) file is periodically created by the server for each client with all relevant changes since the last update. When the clients systems 15, 17, 18 and 19 (FIG. 1) connect to the server 11, the modification files associated with the client are transmitted by the server to be used for updating each client.

The client systems 15, 17, 18 and 19 may each be located at remote sites. Client systems 15, 17, 18 and 19 include but are not limited to, PCs, workstations, laptops, PDAs, pagers, WAP devices, non-WAP devices, cell phones, palm devices and the like. Thus, when a user at one of the remote client systems 15, 17, 18 and 19 desires to be updated with the current information from the shared file at the server 11, the client system 15, 17, 18 and 19 communicates over the network 13, such as but not limited to WAN, internet, or telephone lines to access the server 11.

Third parties computer systems 21 & 23 and databases 22 & 24 can be accessed by the profiles system server 11 in order to obtain information for dissemination to the remote devices. Data that is obtained from third party computer systems 21 & 23 and databases 22 & 24 can be stored on the profiles system server 11 in order to provide later access to the user remote devices 15, 17, 18 and 19. It is also contemplated that for certain types of data that the remote user devices 15, 17, 18 and 19 can access the third party data directly using the network 13. It is also contemplated in an alternative embodiment, that computer system 23 and database 24 to be accessed by remote user devices 15, 17, 18 and 19 through server 11 which acts a conduit to an organization's services.

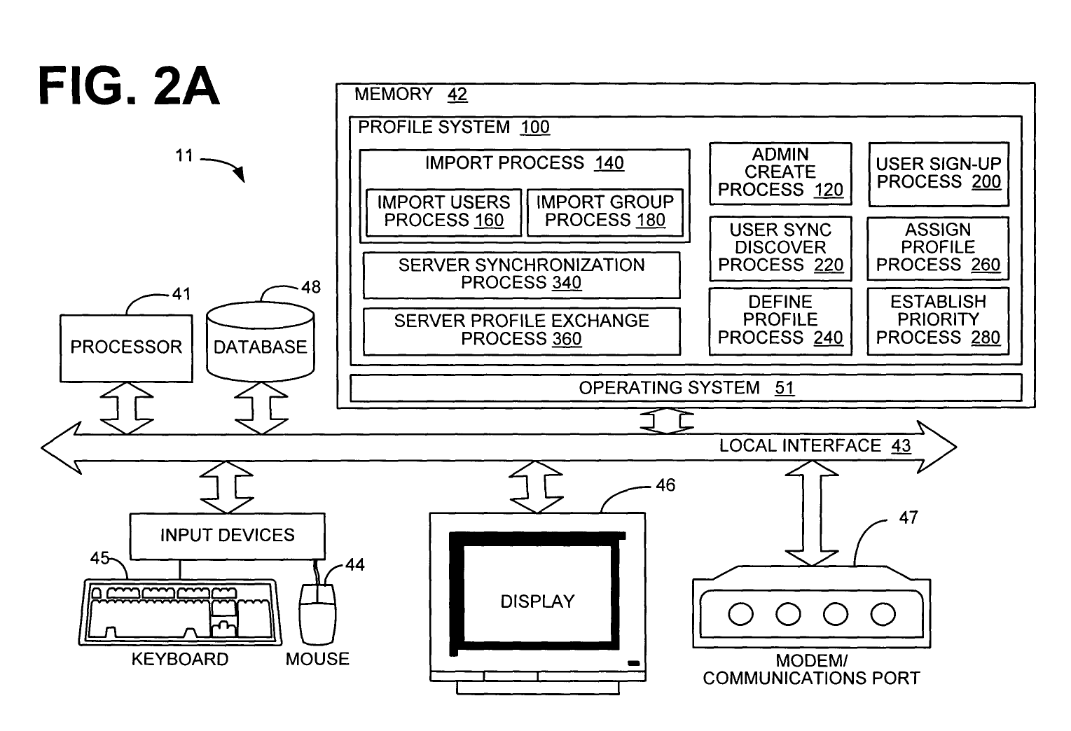

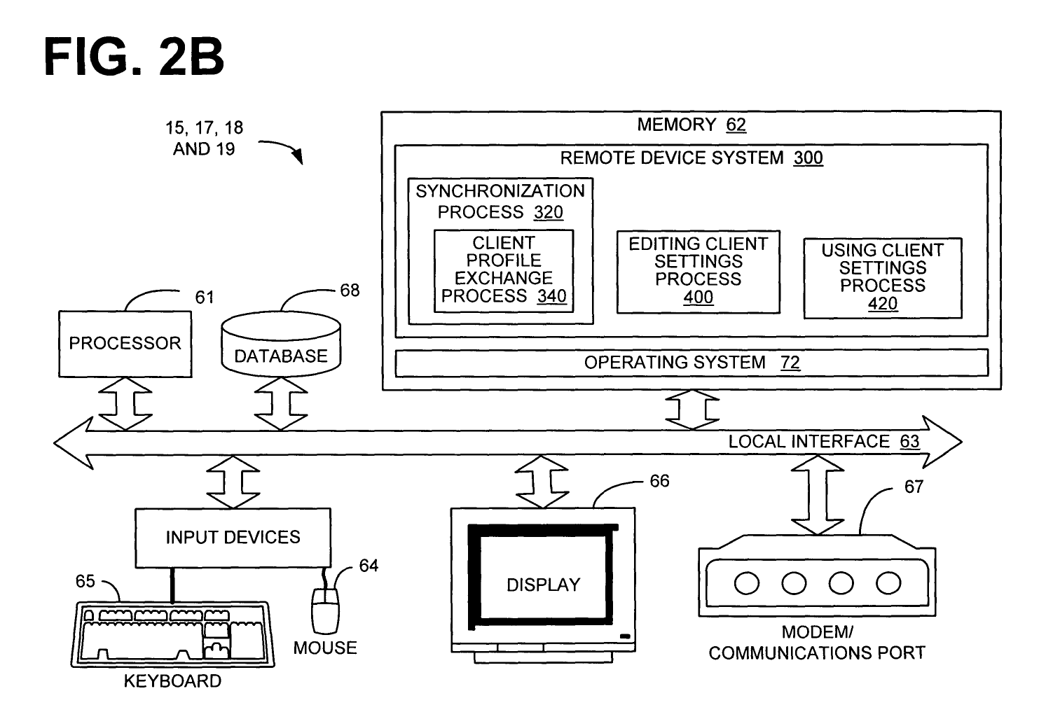

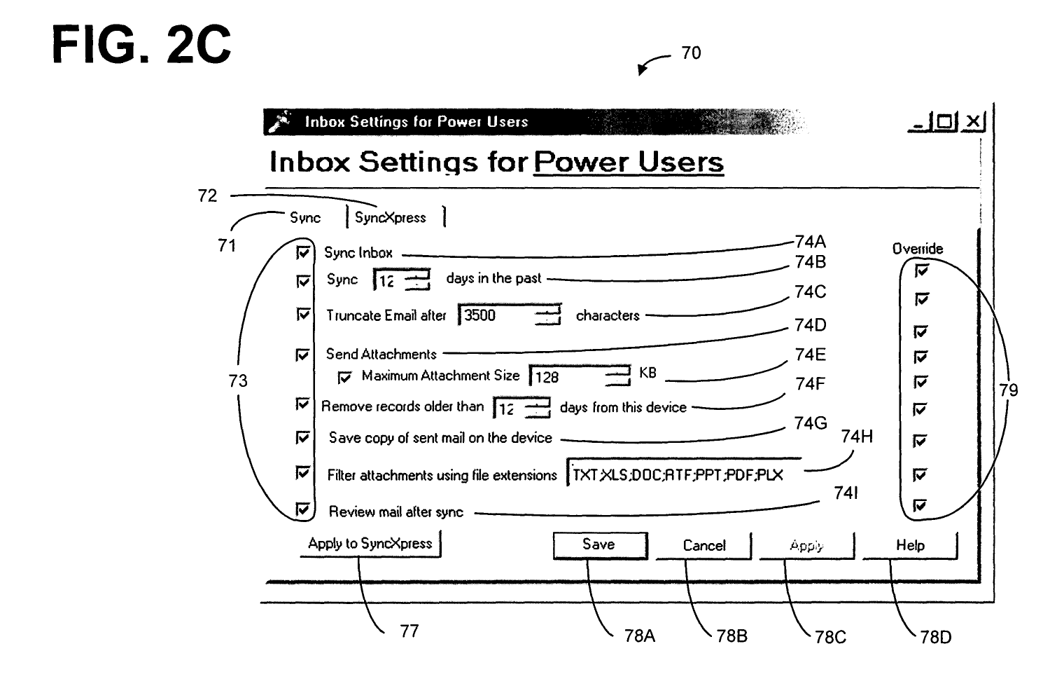

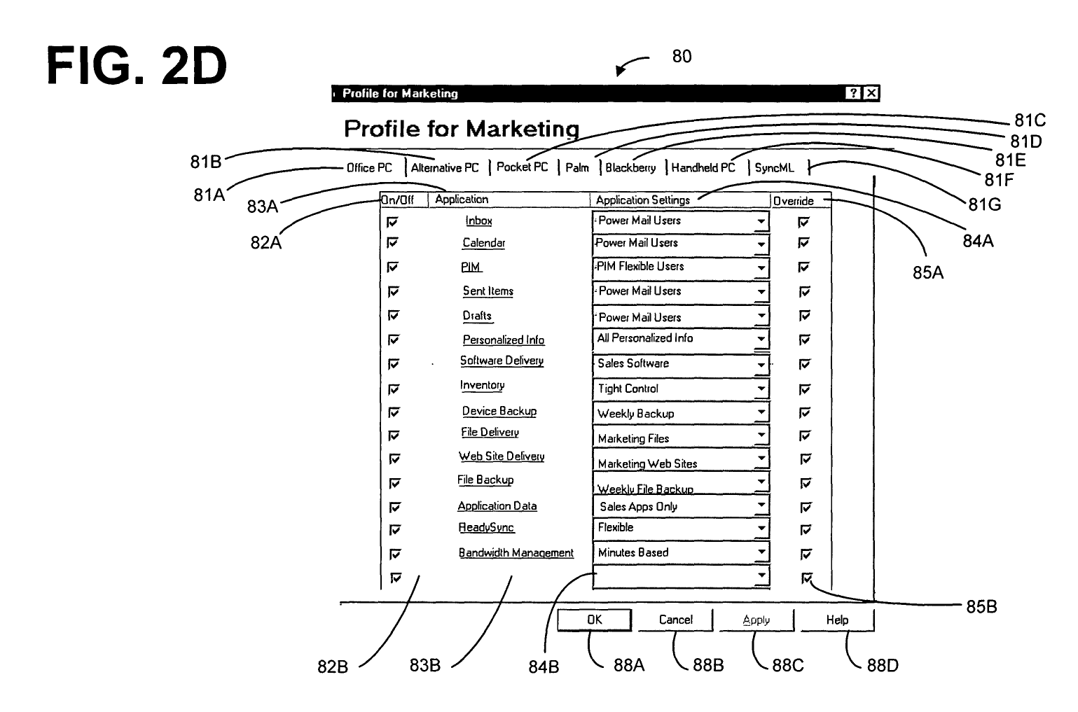

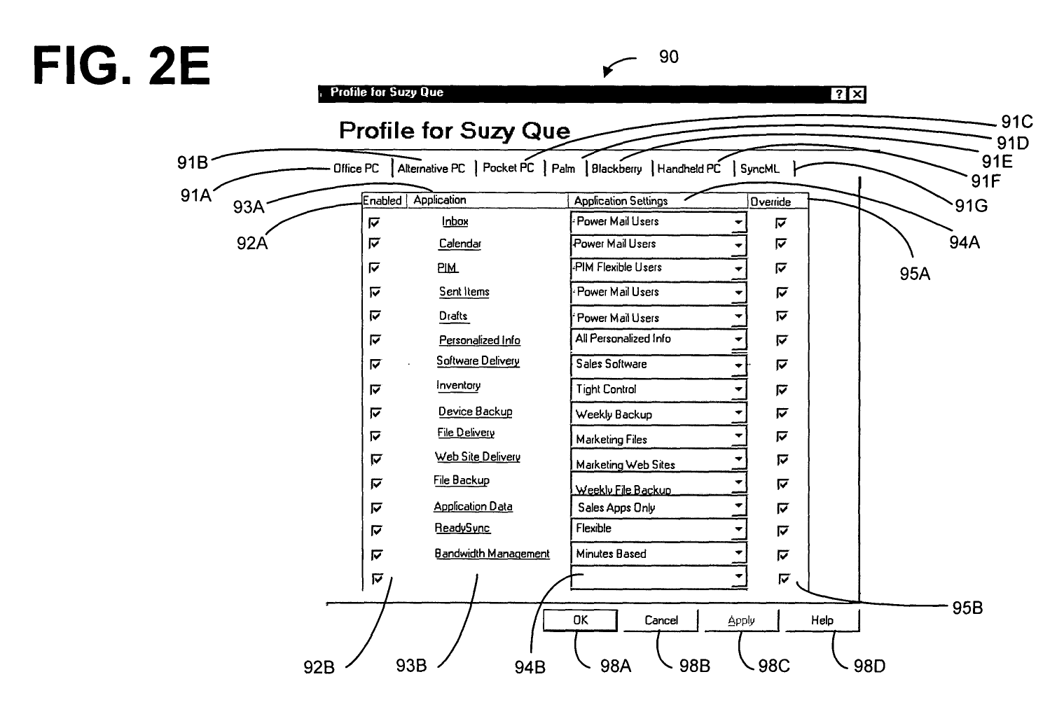

Illustrated in FIG. 2A is a block diagram demonstrating an example of a server 1 1, as shown in FIG. 1, utilizing the profiles system 100 of the present invention. Illustrated in FIG. 2B is an example demonstrating a remote device 15, 17, 18 or 19 utilizing profiles system of the present invention. Remote devices 15, 17, 18 and 19 include, but are not limited to, PCs, workstations, laptops, PDAs, pagers, WAP devices, non-WAP devices, cell phones, palm devices and the like. The components of the remote device 15, 17, 18 and 19 are substantially similar to that of the description for the server 11 (FIG. 2A). However, it is contemplated that many of the components in the user's remote device 15, 17, 18 and 19 can be more limited in general function.

Generally, in terms of hardware architecture, as shown in FIG. 2A, the computer devices 11, 15, 17, 18 and 19 herein include a processor 41, storage 42 memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU) or an auxiliary processor among several processors associated with the computer 11, 21 and 23, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 51 and the profile system 100 of the present invention. In the example illustrated, it is the profile system 100 of the present invention that gives administrators a logical method of grouping general and application settings so that they can be assigned to groups. This is a complex matrix of settings and assignments. The profiles system 100 of the present invention accomplishes three primary goals: (1) Creates a user interface for the administrator that is straightforward and one that will simplify the task for the administrator to create groups of settings that can be assigned to groups and extend the interface to the users where it is appropriate for users to override; (2) Creates a framework that can be used easily by the rest of the applications and (3) Provide the ability for administrator to mandate specific settings.

The profiles system 100 of the present invention operates to enable a system administrator to establish groups of settings and individual settings in order to control the operation of remote devices 15, 17, 18 and 19. The profiles system 100 includes administrative process 120, import process 140, user sign-up process 200, user sync discover process 220, defined profile process 240 assigned profile process 260, establish priority process 280, server synchronization process 340 and server profile exchange process 360.

A non-exhaustive list of examples of suitable commercially available operating systems 51 is as follows: a Windows operating system from Microsoft Corporation, U.S.A., a Netware operating system available from Novell, Inc., U.S.A., an operating system available from IBM, Inc., U.S.A., any LINUx operating system available from many vendors or a UNIX operating system, which is available for purchase from many vendors, such as Hewlett-Packard Company, U.S.A., Sun Microsystems, Inc. and AT&T Corporation, U.S.A. The operating system 51 essentially controls the execution of other computer programs, such as the profile system 100, and provides scheduling, input-output control, file and data management, memory management, and communication control and related services. However, it is contemplated by the inventors that the profile system 100 of the present invention is applicable on all other commercially available operating systems.

The profile system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the profile system 100 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java,, ADA and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing other files, devices, systems, or a network), a radio frequency (RF) or other transceiver such as Wi-Fi or the like (not shown), a telephonic interface (not shown), a bridge (not shown), a router (not shown), etc.

If the computers 11, 21 and 23 are a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the computer 11, 15, 16, 18, 19, 21 and 23 are activated.

When the computers 11, 15, 16, 18, 19, 21 and 23 are in operation, the processor 41 is configured to execute software stored within the memory 42, to communicate data to and from the memory 42, and to generally control operations of the computer 11, 15, 16, 18, 19, 21 and 23 pursuant to the software. The profile system 100 and the O/S 51 are read, in whole or in part, by the processor 41, perhaps buffered within the processor 41, and then executed.

When the profile system 100 is implemented in software, as is shown in FIGS. 2A and 2B, it should be noted that the profile system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The profile system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the profile system 100 is implemented in hardware, the profile system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of a remote device 15, 17, 18 and 19 utilizing the profile system 100 of the present invention, as shown in FIG. 1. As illustrated, the remote device 15, 17, 18 and 19 includes many of the same components as server 11 described with regard to FIG. 2A. Located in memory 62 is the remote device system 300 which includes the following processes, such as but not limited, synchronization process 320 that further includes the client profile exchange process 340, editing client settings process 360 and using client settings process 400. When the remote device system 300 is implemented in software, as is shown in FIG. 2B, it can be stored on virtually any computer readable medium for use by or in connection with any computer related system or method.

In an alternative embodiment, where the remote device system 300 is implemented in hardware, the remote device system 300 can be implemented in the same way as described above with regard to the profile system 100 (FIG. 2A). In the example illustrated, it is the client profile exchange process 340, editing client settings process 400 and using client settings process 420 to interact with the profile system 100 of the present invention. The client profile exchange process 360 enables the creation of user profiles, the editing client settings process 400 provides the functionality for a user to add it the profile settings, and using client settings process 420 is the illustrated example for utilizing the profile settings.

Illustrated in FIG. 2C is a diagram demonstrating an example of a user interface for inputting the example Inbox settings 70 for the example Power Users group that can be utilized by the profile system 100 of the present invention, as shown in FIG. 1. As shown, the example of inbox settings 70 for power users in user interface includes a variety of different types of settings. The settings for the inbox settings 70 are to individual types of settings that do not include reference to other profiles, therefore, inbox settings 70 are an example of a stand-alone profile.

For example, the first type of settings is for the inbox settings for power users group, and include the Sync 71 and SyncXpress 72 settings. The inbox settings 70 for the power user group for Sync 71 are the settings for a full synchronization of a remote device, regardless of connection or device type. The inbox settings for the power user group for SyncXpress 72 are for a limited synchronization of a remote device. This type of limited synchronization is generally performed during peak times where the cost of transmitting data is extremely high. A synchronization operation for SyncXpress 72 settings is also preferred when the connection is of low quality or bandwidth. This is because a low bandwidth connection will limit the amount of data transmitted in a period of time therefore; just the minimal amount of data transmitted will be desired.

Inbox settings 70 for power users using Sync 71 settings include, but are not limited to, the type of synchronization functions to be performed. The way a particular type of setting is indicated to be included in a Sync operation in the illustrated example, are by actively marking boxes 73 for each type of inbox synchronization function desired. Types of synchronization inbox settings 70 include for example, but are not limited to, whether the synchronization of the inbox 74A is to occur, the number of days in which a synchronization is to occur 74B, whether a e-mail is to be truncated after an indicated number of characters 74C, whether or not attachments are to be sent and the maximum attachments size as indicated by 74D and 74E respectively. Other examples of inbox settings 70 for power users are whether records older than a indicated number of days are to be removed 74F from the remote device 15, whether copies of e-mail sent are to be stored 74G on the remote device 15, with types of file extensions are to be filtered as indicated in 74H, and whether a review of mail is to occur after a synchronization 741.

An additional setting 77 includes whether to apply the same inbox settings for power users, as defined for the Sync 71 settings to the SyncXpress 72 settings. Operational controls include, but are not limited to, save 78A the settings, cancel 78 the settings, apply the settings 78C, or help with the settings functions 78D. Still another additional setting is whether or not the user can override 79 a feature functions setting 74A through 741 using the override setting 79. By implementing the setting, the profile enables a user to override any of the previously set profile settings for features or functions defined in items 74A through 74I.

The inbox group settings 70 described above are only for illustration purposes to demonstrate what types of settings are possible in the profile that can be created by the profile system 100 of the present invention.

Illustrated in FIG. 2D is a diagram demonstrating an example of a user interface for inputting the example profile settings for the example Marketing setting 80 that can be utilized by the profile system 100 of the present invention, as shown in FIG. 1. The marketing settings 80 is a profile that includes reference to other groups of settings or profiles. References to other groups of settings of profiles can be the standalone profile as shown in FIG. 2C above, or include assignments to other group profile settings as shown in the reference to application settings 84B. These group settings allow an administrator to indicate a number of different settings.

The marketing group settings 80 include settings for a variety of different types of devices that include, but are not limited to, an office PC 81A, alternative PC 81B, pocket PC 81C, palm 81D, blackberry device 81E, handheld PC 81F, and SyncML device 81G. There is a profile for each type of device 81 A-8 1 G that includes settings for different feature/functions. This is an example of an environmental characteristic, the device type, being a key to resolving a profile for a computer operation.

The user interface for each device includes a number of different setting headers that further include on/off 82A, application 83A, application settings 84A and override 85A. The actual settings for each device type and category are indicated below the heading and include on/off settings 82B, applications 83B, application settings 84B (i.e. which can include other profile listings) and override settings 85B.

The on/off 82B settings enable an administrator to indicate whether the application listed in 83B are enabled for the device type indicated in 81. In area 84B, the administrator indicates which type of application settings are to be utilized for the application indicated in 83B. These application settings 80B can be standalone profile settings, as discussed above with regard to FIG. 2C, or can be other groups of profile settings. Still another additional setting is whether or not the user can override 85B the setting in 84B. By implementing the setting, the profile enables a user to override any of the previously set profile settings for feature/functions defined in items 82B-84B.

Additional settings include operational controls that include, but are not limited to, save 88A the settings, cancel 88 the settings, apply the settings 88C, or help with the settings functions 88D.

The Marketing group settings described above are described only for illustration purposes to demonstrate what types of settings are possible in the profile groupings that can be created by the profile system 100 of the present invention.

Illustrated in FIG. 2E is a diagram demonstrating an example of a user interface for the example profile settings for the example individual user settings 90 for “Suzy Que” that can be utilized by the profile system 100 of the present invention, as shown in FIG. 1. For illustration purposes, the point settings for an individual user 90 are shown as the same as the marketing profile described above with regard to FIG. 2D. However, it is understood that different applications and application settings may be defined for individual users as opposed to a group profile as illustrated for the marketing group settings 80 in FIG. 2D.

The individual user Suzy Que profile settings described above are described only for illustration purposes to demonstrate what types of settings are possible in the profile groupings that can be created by the profile system 100 of the present invention.

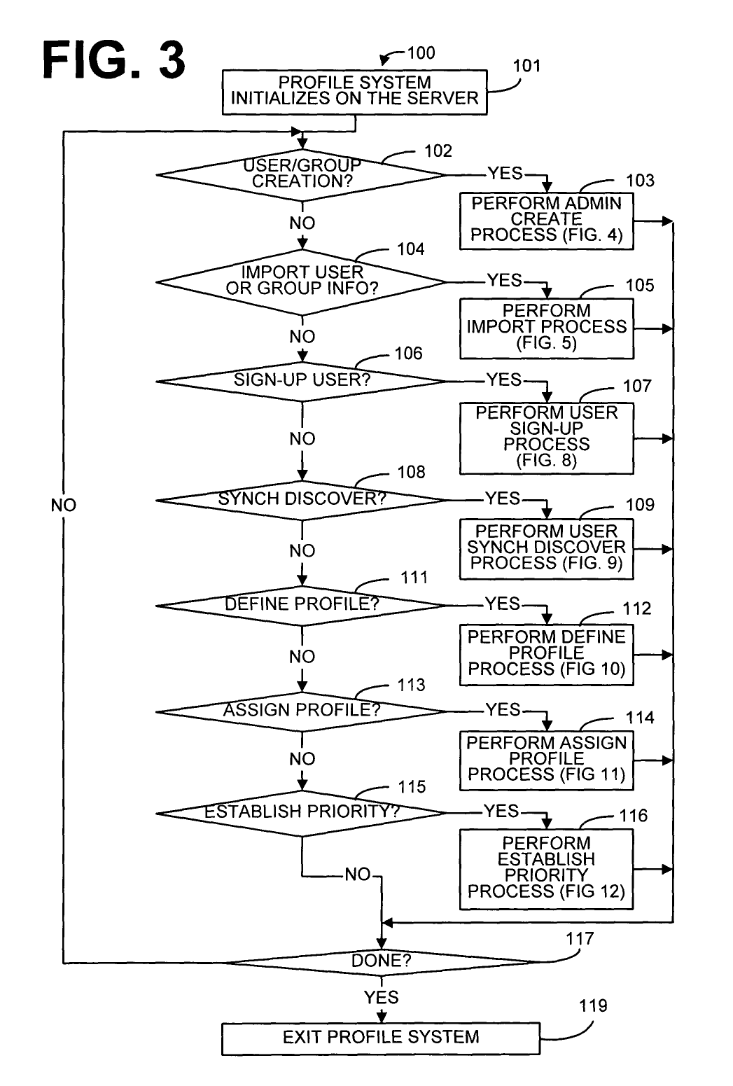

Illustrated in FIG. 3 is a flow chart demonstrating an example of the operation of the profile system 100 of the present invention on a server 11, as shown in FIGS. 1 and 2A. The profile system 100 of the present invention gives administrators a logical method of grouping general and application settings so that they can be assigned to groups. This is a matrix of settings and assignments. Furthermore, the profile system 100 of the present invention provides a user interface for the administrator that is straightforward and one that will simplify the task for the administrator to create groups of settings that can be assigned to groups and extend the interface to the users where it is appropriate for users to override. It also creates a framework that can be used easily by other applications. Moreover, the profile system 100 of the present invention provides the ability for administrator to mandate specific settings, or simply set default characteristics of the activities of synchronization, and set only the settings that apply to those users or groups.

First at step 101, the profile system 100 is the initialized. This initialization includes the startup routines and process embedded in the BIOS of the server 11. The initialization also includes the establishment of data values for particular data structures utilized in the profile system 100.

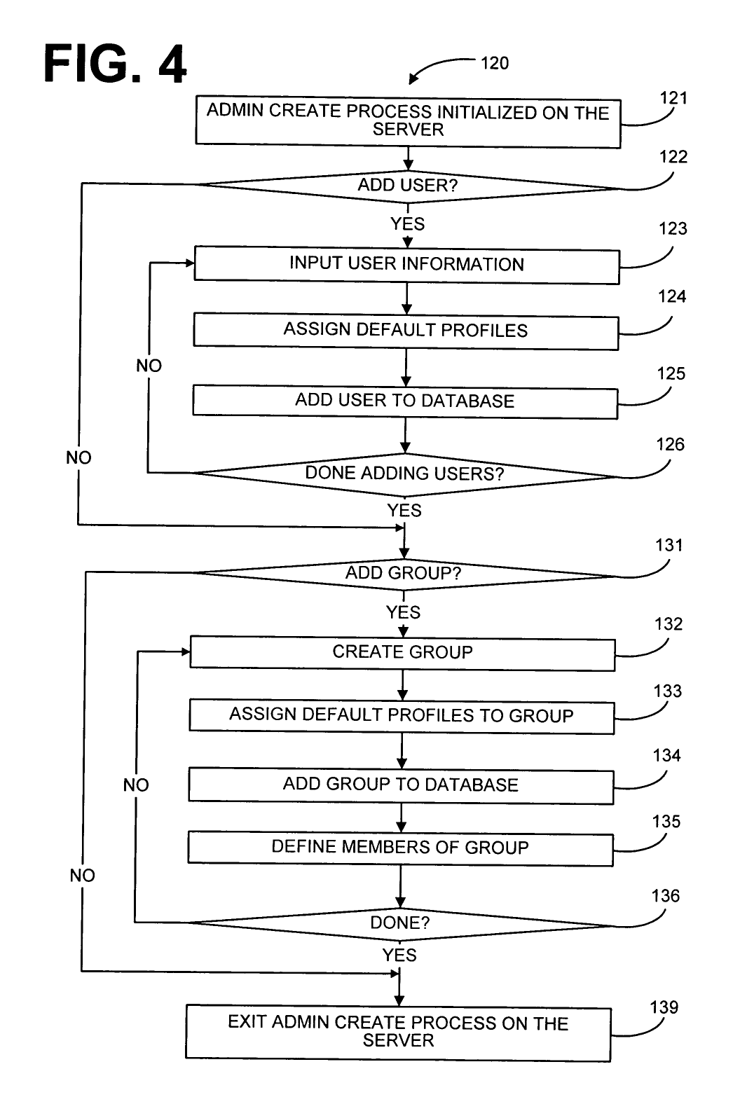

At step 102, the profile system 100 determines if a user or group creation has been indicated. A user or group creation enables an administrator to create a new user or group. If it is determined at step 102 that a user or group creation has not been indicated, the profile system 100 proceeds to step 104. However, if it is determined at step 102 that a user or group creation has been indicated, the profile system 100 performs the admin create process at step 103. The admin create process as herein defined in further detail with regard to FIG. 4. After performing the admin create process at step 103, the profile system 100 proceeds to step 117.

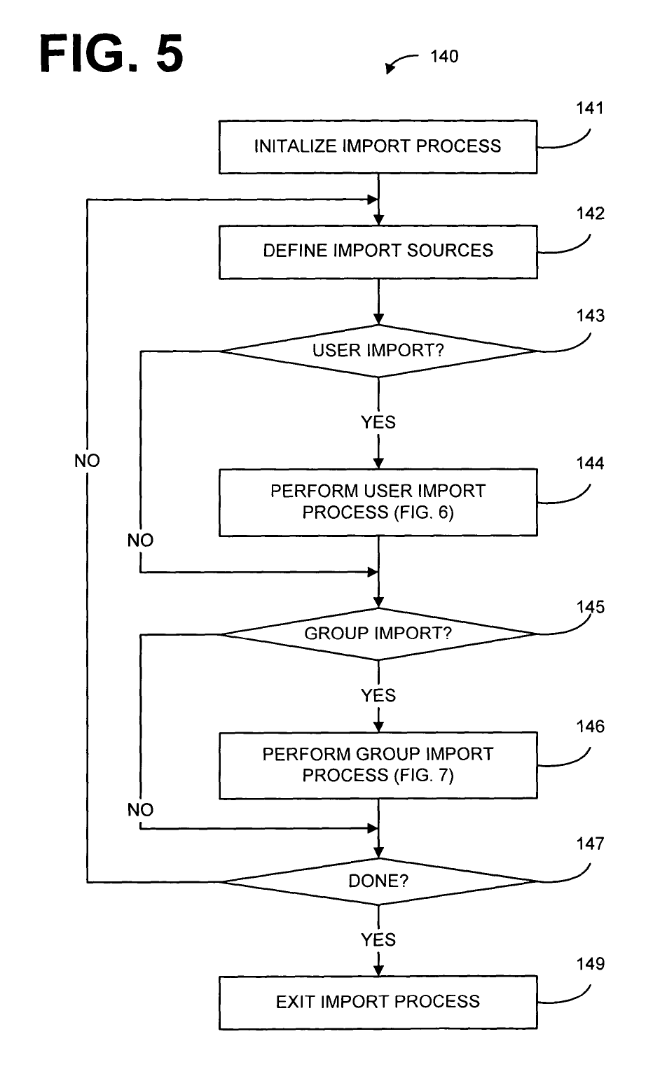

At step 104, the profile system 100 determines if a user or group information import operation has been indicated. The user or group information import operation allows a administrator to import settings for a new user or group. If it is determined at step 104 that a user or group import operation has not been indicated, the profile system 100 proceeds to step 106. However, if it is determined at step 104 that a user or group import operation has been indicated, the profile system 100 performs the import process at step 105. The import process as herein defined in further detail with regard to FIG. 5. After performing the import process at step 105, the profile system 100 proceeds to step 117.

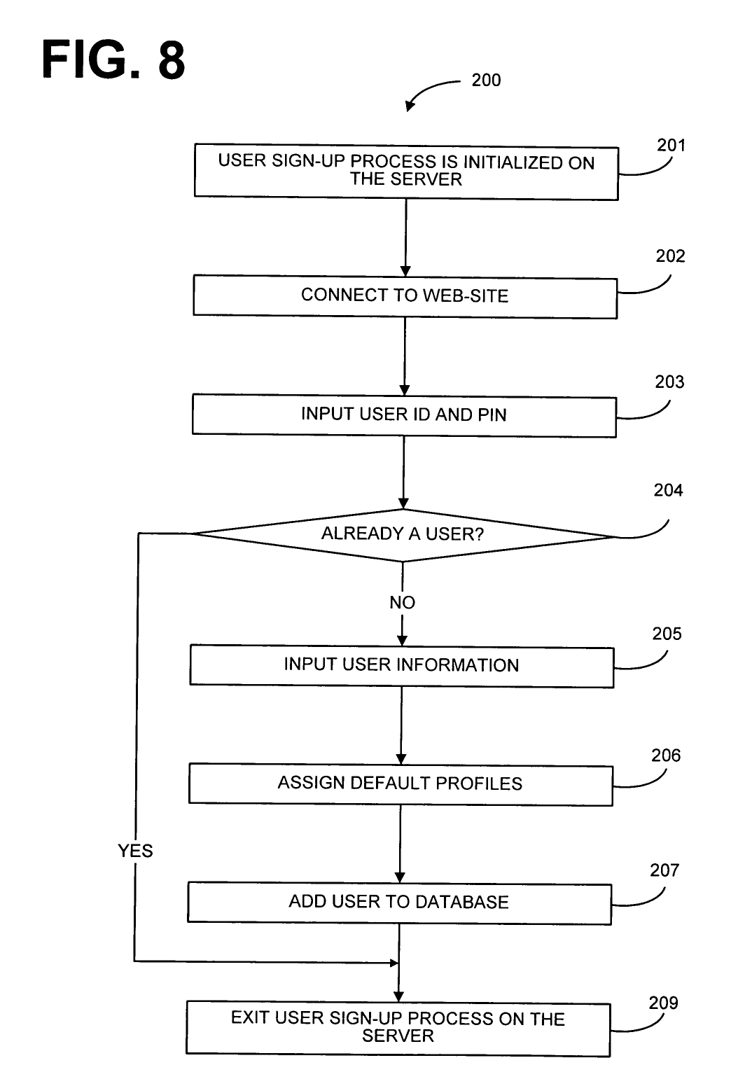

At step 106, the profile system 100 determines if a user sign-up has been indicated. A user sign-up indication will occur when a new user registers with the profile system 100. If it is determined at step 106 that a user sign-up has not been indicated, the profile system 100 proceeds to step 108. However, if it is determined at step 106 that a user sign-up has been indicated, the profile system 100 performs the user sign-up process at step 107. The user sign-up process as herein defined in further detail with regard to FIG. 8. After performing the user sign-up process at step 107, the profile system 100 proceeds to step 117.

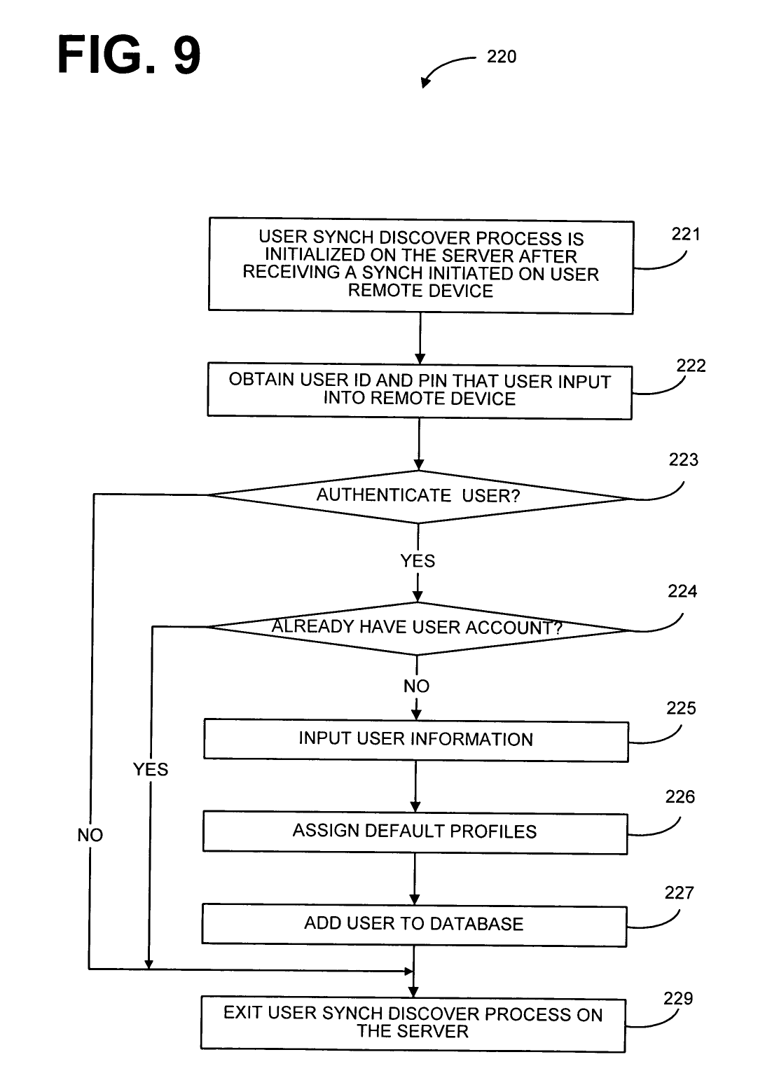

At step 108, the profile system 100 determines if a user has been discovered during synchronization. The profile system 100 enables a user to register during a related synchronization operation. If it is determined at step 108 that a new user has not been discovered during synchronization, the profile system 100 proceeds to step 111. However, if it is determined at step 108 that a user has been discovered during synchronization then the profile system 100 performs the user sync discover process at step 109. The user sync discover process as herein defined in further detail with regard to FIG. 9. After performing the user sync discover process at step 109, the profile system 100 proceeds to step 117.

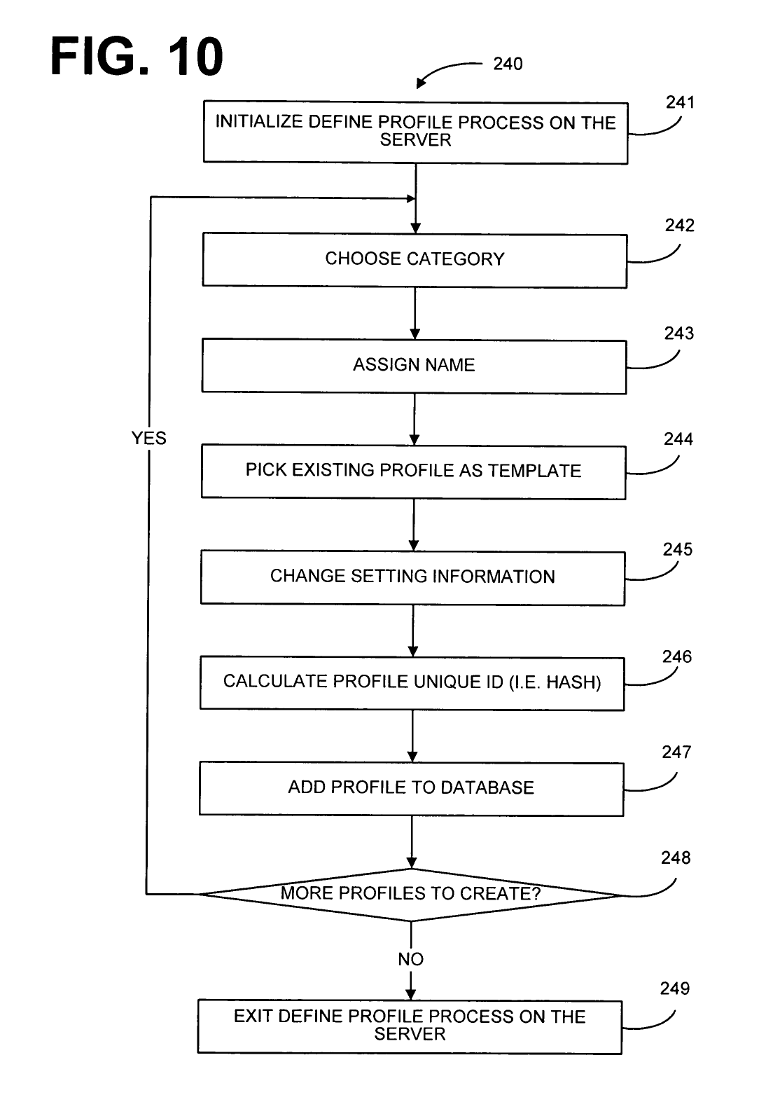

At step 111, the profile system 100 determines if a defined profile operation has been indicated. The defined profile operation allows an administrator to define a new profile. If it is determined at step 111 that a defined profile operation has not been indicated, the profile system 100 proceeds to step 113. However, if it is determined at step 111 that a defined profile operation has been indicated, the profile system 100 performs the define profile process at step 112. The define profile process as herein defined in further detail with regard to FIG. 10. After performing the define profile process at step 112, the profile system 100 proceeds to step 117.

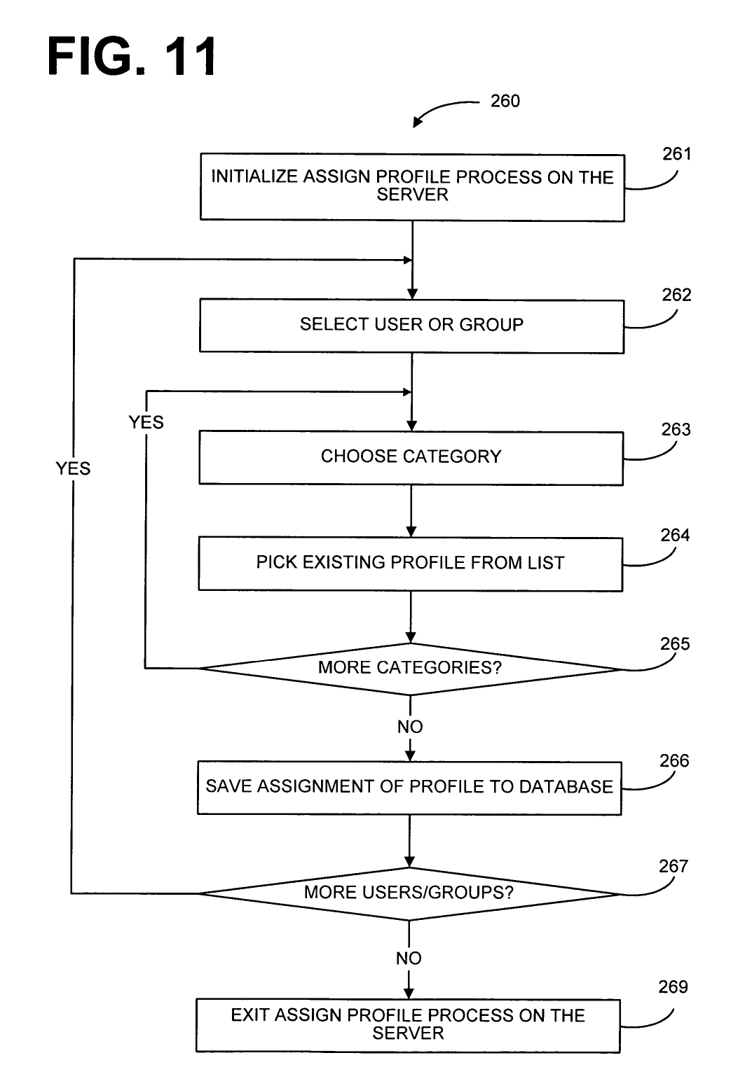

At step 113, the profile system 100 determines if an assign profile operation has been indicated. An assign profile indication will occur when an administrator desires to assign an existing profile settings to a newly created profile. If it is determined at step 113 that an assign profile operation has not been indicated, the profile system 100 proceeds to step 15. However, if it is determined at step 113 that an assign profile operation has been indicated, the profile system 100 performs the assign profile process at step 114. The assign profile process as herein defined in further detail with regard to FIG. 11. After performing the assign profile process at step 114, the profile system 100 proceeds to step 117.

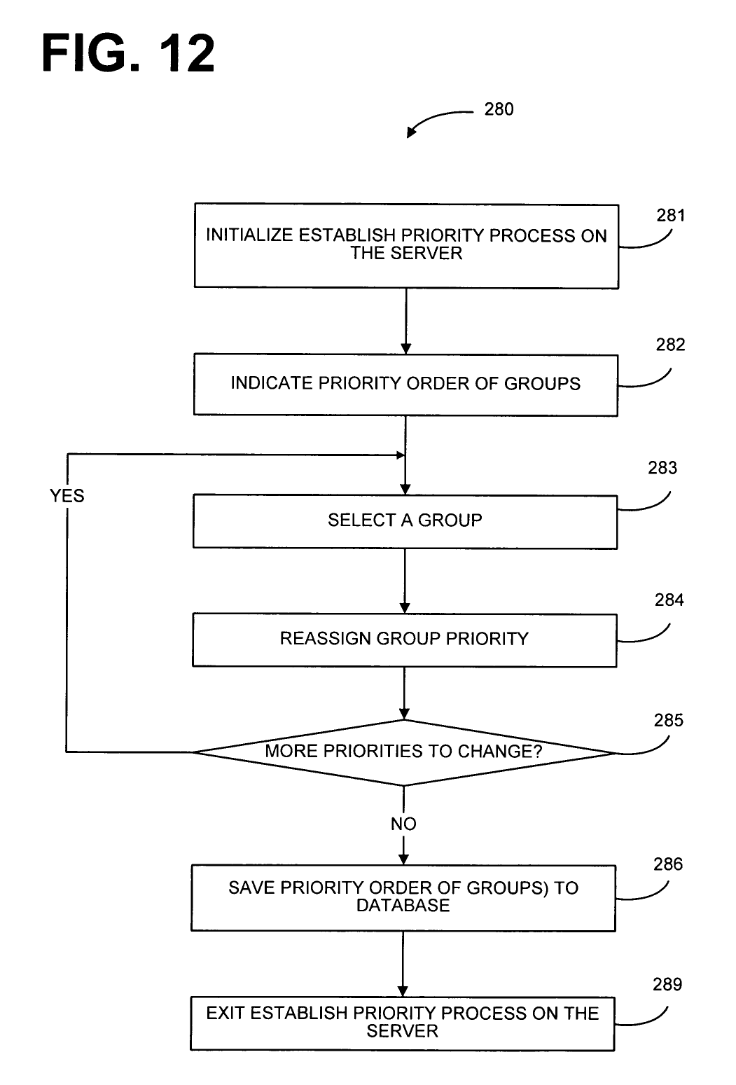

At step 115, the profile system 100 determines if an establish priority operation has been indicated. An establish priority operation indication will occur when an administrator desires to assign priorities to existing profile settings. If it is determined at step 115 that an establish priority operation has not been indicated, the profile system 100 proceeds to step 117. However, if it is determined at step 115 that an establish priority operation has been indicated, the profile system 100 performs the establish priority process at step 116. The establish priority process as herein defined in further detail with regard to FIG. 12. After performing the establish priority process at step 116, the profile system 100 proceeds to step 117.

At step 117, the profile system 100 determines if there are more operations to be performed. If it is determined at step 117 that there are more operations to be performed, the profile system 100 returns to repeat steps 102 through 117. However, if it is determined at step 117 that there are no more operations to be performed, the profile system 100 then exits at step 119.

Illustrated in FIG. 4 is a flow chart demonstrating an example of the admin create process 120 utilized by the profile system 100 of the present invention, as shown in FIGS. 1-3. The admin create process 120 enables an administrator to create a new user or group. A new user or group can include, but is not limited to, identification, first name, last name, address and the like.

First, the admin create process 120 is initialized at step 121, and performs similar functions as the initialization of the profile system 100 as described above. The initialization also includes the establishment of data values for particular data structures utilized in the admin create process 120.

Next at step 122, the admin create process 120 determines if a user addition operation is to be performed. If it is determined that a user addition operation is not to be performed, the admin create process 120 proceeds to step 131. However, if it is determined that a user addition operation is to be performed, the admin create process 120 then allows for the input of user information at step 123. In the preferred embodiment, the administrator inputs the user information. This information can be input utilized saying in a number of different input device means, including, but not limited to, a graphical user interface (GUI). An alternative embodiment, this information may be captured from another data source either on or connected to server 11.

At step 124 the administrator assigns the default profile to be included for the user. At step 125 the administrator adds the user to the database, and determines at step 126 if there are more users to be added. If it is determined at step 126 that there are more users to be added, the admin create process 120 then returns to repeat steps 123 through 126.

At step 131, the admin create process 120 determines if an add group operation is to be performed. If it is determined at step 131 that an add group operation is not to be performed, the admin create process 120 then proceeds to step 139 to exit. However, if it is determined at step 131 that an add group operation is to be performed, the admin create process 120 then enables the administrator to create a new profile group at step 132. At step 133, the administrator may assign a default profile to the group. This default profile includes default settings that maybe later changed by the administrator. Then, the admin create process 120 adds the group to the database 12 at step 134

At step 135, the administrator defines the members of the group added. At step 136, the admin create process 120 determines if there are more groups to be added. If it is determined at step 136 that there are more groups to be added, the admin create process 120 returns to repeat steps 132 through 136. However, if it is determined at step 136 that there are no more groups to be added, the admin create process 120 then exits at step 139.

Illustrated in FIG. 5 is a flow chart demonstrating an example of the operation of the import process 140 utilized by the profile system 100 of the present invention, as shown in FIGS. 2A-3. The import process 140 enables an administrator to import information from other sources into newly created user and/or group profiles.

First, the import process 140 is initialized at step 141, and performs similar functions as the initialization of the profile system 100 as described above. The initialization also includes the establishment of data values for particular data structures utilized in the import process 140.

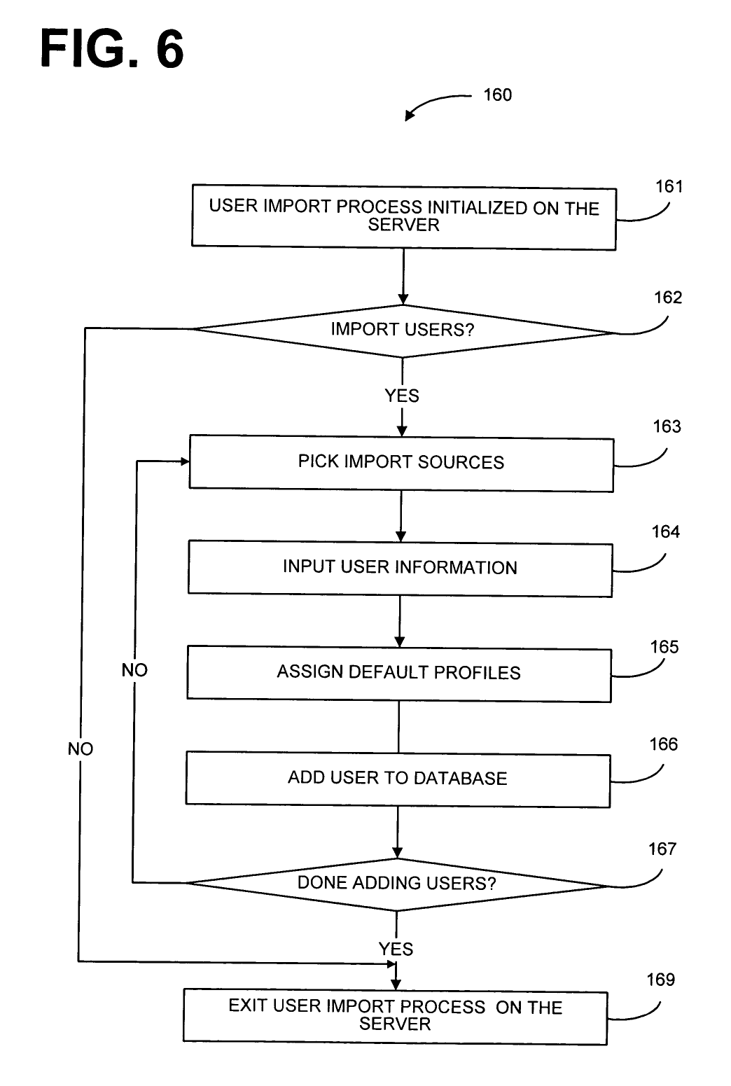

Next at step 142, the import sources are defined. The sources may be defined by administrator inputs through any number of known input devices, such as a user interface or dialog box, or can be made programmatically. At step 143 if it is determined that user information is to be imported. If it is determined at step 143 that user information is not to be imported, the import process 140 then skips to step 145. However, it is determined at step 143 that user information is to be imported, the import process 140 then performs the user import process at step 144. The user import process as herein defined further detail with regard to FIG. 6.

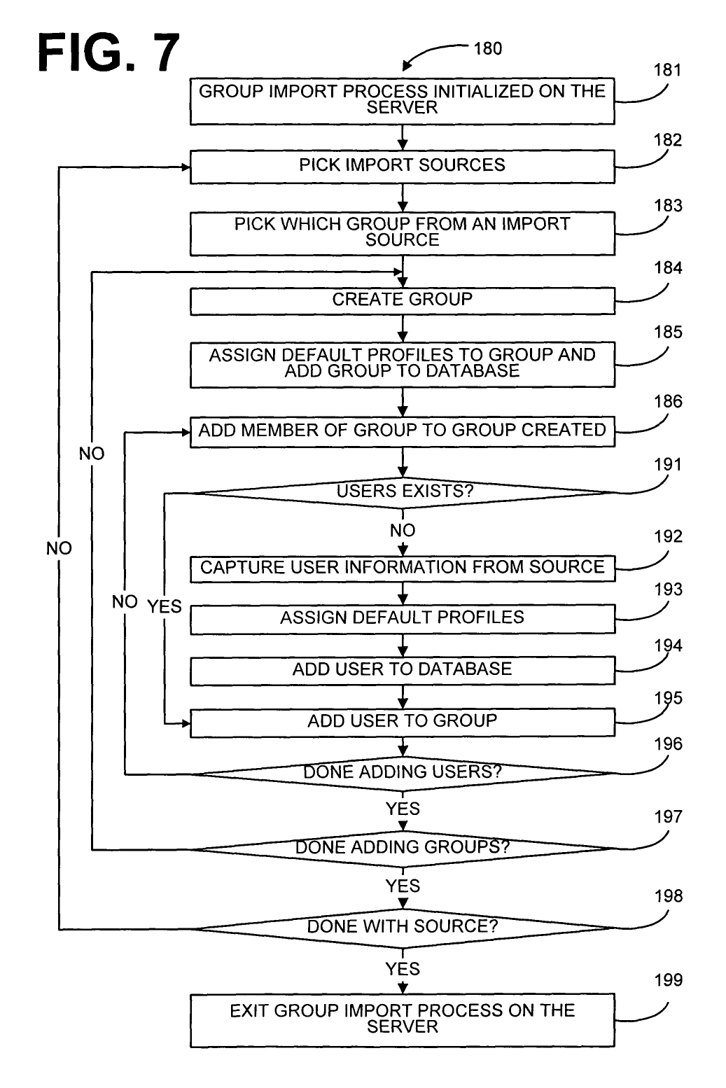

At step 145, it is determined if group information is to be imported. If it is determined at step 145 that group information is not to be imported, the import process 140 then proceeds to step 147. However, if it is determined to step 145 that group information is to be imported, the import process 140 then performs a group import process at step 146. The group import process is herein defined further detail with regard to FIG. 7.

At step 147, the import process 140 determines if more users and/or groups are to be imported. If it is determined at step 147 that more users or groups are to be imported, the import process 140 then returns to repeat steps 142 through 147. However, it is determined that step 147 that there are no more users or groups to be imported, the import process 140 then exits at step 149.

Illustrated in FIG. 6 is a flow chart demonstrating an example of the operation of the user import process 160 utilized by the profile system 100 of the present invention, as shown in FIGS. 2A-3. The user import process 160 is performed in order to import information and create new users in the database 12 for the profile system 100.

First, the user import process 160 is initialized at step 161, and performs similar functions as the initialization of the profile system 100 as described above. The initialization also includes the establishment of data values for particular data structures utilized in the user import process 160.

At step 162, the user import process and determines if there are users to be imported. If it is determined to step 162 that there are no users to be imported then the user import process 160 proceeds to step 169 and exits. However, if it is determined at step 162 that there are users to be imported, the user import process 160 then enables the administrator to pick the import sources at step 163. The selection of import sources can be made the utilizing a user interface or dialog box, or can be made programmatically. In the preferred embodiment, available inputs sources are displayed in a user interface to allow an administrator to select the import sources desired.

At step 164 the user import process 160 provides for the input of user information. The input of user information can be made utilizing a user interface or dialog box, or can be accomplished programmatically utilizing the input of data files. At step 165 the administrator assigns a default profile for the user import process 160. At step 166 the user information is added to database 112 in the profile system 100.

At step 167 in the user import process 160 determines if it is done adding users. If it is determined at step 167 that there are no more users to be added, then the user import process 160 exits at step 169. However, if it is determined that there are more users to be added, the user import process 160 returns to repeat steps 163 through 167.) Illustrated in FIG. 7 is a flow chart demonstrating an example of the operation of the group import process 180 utilized by the profile system 100 of the present invention, as shown in FIGS. 2A-3. The group import process 180 is performed in order to import information and create new groups in the database 12 for the profile system 100.

First, the group import process 180 is initialized at step 181, and performs similar functions as the initialization of the profile system 100 as described above. The initialization also includes the establishment of data values for particular data structures utilized in the group import process 180.

At step 182, the group import process enables the administrator to select the import sources. The selection of import sources can be made the utilizing a user interface or dialog box, or can be made programmatically. In the preferred embodiment, available inputs sources are displayed in a user interface to allow an administrator to select the import sources desired. At step 183, the group import process 180 enables an administrator to pick which group is to be created from the selected import sources (step of 182).

At step 184, the group import process 180 creates a new group. At step 185, the new group is assigned default profiles and is added to database 12. These assigned default profiles can be assigned by the administrator or programmatically. In the preferred embodiment, a user interface is displayed to enable an administrator to select the default profiles to be included in the group.

At step 186, members of a group may be the added to the group just created. At step 191, the group import process 180 determines if the member added to the group created at step 186 exists. It is determined at step 191 that the user added as a member of a group currently exist, then the group import process 180 proceeds to step 195. However, if it is determined at step 191 that a member added to a group does not exist, then the group import process 180 captures the user information from the selected source at step 192. At step 193, the group import process 180 assigns a default profile and adds the user to the database 12 at step 194.

At step 195, the now defined user is added to the group. At step 196, it is determined if there are no more users to add to a group. If it is determined at step 196 that there are more users to add to the newly created group, the group import process 180 returns to repeat steps 186 through 196.

However it is determined to step 196 that there are no more users to add to a group, then the group import process 180 determines if there are more groups to be added to the newly created group. If it is determined at step 197 that there are more groups to be added, then the group import process 180 returns to repeat steps 184 through 197.

However, it is determined at step 197 that there are no more groups to be added for the currently selected sources, the group import process 180 determines if there are more sources for groups to be processed at step 198. It is determined at step 198 that there are more sources to be processed, the group import process 180 returns to repeat steps 182 through 198. However, it is determined that there are no more sources to be process, the group import process 180 then exits at step 199.

Illustrated in FIG. 8 is a flow chart demonstrating an example of the operation of the user sign-up process 200 utilized by the profile system 100 of the present invention, as shown in FIGS. 2A-3. A user sign-up process 200 is performed when a new user registers with the profile system 100. While the example of the operation of the user sign up process includes the connection to a web site, it is understood that other types of network connections may be utilized.

First, the user sign-up process 200 is initialized at step 201, and performs similar functions as the initialization of the profile system 100 as described above. The initialization also includes the establishment of data values for particular data structures utilized in the sign-up process 200. At step 202, the user sign-up process 200 accepts a connection to a web site. However, it should be understood that this function may be accomplished through any type of connection to a server.

At step 203, the user sign-up process 200 accepts the user ID and PIN input. At step 204, the user sign-up process 200 determines if connected user is already a registered user. If it is determined at step 204 that the connected user is already a registered user, then the sign-up process 200 proceeds to step 209.

However, if it is determined at step 204 that the connected user is not already a registered user, then the user sign-up process 200 accepts the input of user information at step 205. At step 206, the user sign-up process 200 assigned default profiles to the user and adds the user to the database 12 at step 207. The user sign-up process then exited step 209

Illustrated in FIG. 9 is a flow chart demonstrating an example of the operation of the user sync discover process 220 utilized by the profile system 100 of the present invention, as shown in FIGS. 2A-3. The user sync discover process 220 enables a user to register during a related synchronization operation. The synchronization example described herein to defined the profile system 100 of the present invention is enabled with a feature to enable a user to register with a synchronization service during a synchronization operation.

First, the user sync discover process 220 is initialized at step 221, and performs similar functions as the initialization of the profile system 100 as described above. The initialization also includes the establishment of data values for particular data structures utilized in the user sync discover process 220.

At step 222, the user sync discover process 220 accepts the user input ID and PIN information. At step 223, the user sync discover process 220 determines if the user is an authenticated user. If it is determined that the user is not an authenticated user, the user sync discover process 220 then proceeds to step 229. Otherwise, if the user is an authenticated user, then the user sync discover process 220 then determines if the user already has an account at step 224. It is determined at step 224 that the user already has an account then the user sync discover process 220 then proceed to step 229.

However, if it is determined at step 224 that the user does not already have an account than the user sync discover process 220 then allows the user to input user information at step 225. In the preferred embodiment, this information is acquired using a user interface on the remote device 15, 17, 18 and 19. At step 226 the user sync discover process 220 assigned default profiles and then adds the user to the database at step 227. The user sync discover process 220 then exits at step 229.

Illustrated in FIG. 10 is a flow chart demonstrating an example of the operation of the define profile process 240 utilized by the profile system 100 of the present invention, as shown in FIGS. 2A-3. The define profile process 240 allows an administrator to define a new profile. In the preferred embodiment, a new profile is created using a existing profile as a template. Generally, this is understood by the inventors to be a more efficient methodology of creating a profile. However, it is understood by the inventors said other ways including the creation of a profile and assignment of individual profile settings can be performed.

First, the define profile process 240 is initialized at step 241, and performs similar functions as the initialization of the profile system 100 as described above. The initialization also includes the establishment of data values for particular data structures utilized in the define profile process 240.

At step 242, the define profile process 240 allows the administrator to choose a category for a profile to be defined. At step 243, the administrator provides the assigned name of the new profile. At step 244, the administrator is able to select an existing profile to be used as a template for the new profile. The administrator of generally tries to select the existing profile that more closely resembles the input of the desired new profile. It is understood, that new profiles can be independently created, however, it is assumed that copying existing profiles and making just the required changes it is more efficient. The define profile process 240 allows the administrator to change the existing settings in the new proof profile, at step 245 as desired.

A new unique profile ID is then calculated at step 246. This unique profile ID can be any type of unique identifier. In the preferred embodiment, a hash ID is created from the information within the profile. At step 247, the new profile is added to the database 12. At step 248, it is determined if more profiles are to be created. If it is determined that more profiles are to be created, the define profile process 240 then returns to repeat steps 242 through 248. However, if it is determined at step 248 that there are no more profiles to be created, the define profile process 240 exited step 249.

Illustrated in FIG. 11 is a flow chart demonstrating an example of the operation of the assign profile process 260 utilized by the profile system 100 of the present invention, as shown in FIGS. 2A-3. The assign profile process 260 allows an administrator to assign different existing profiles to user and/or group profiles. In the existing profiles can be stand-alone profiles or a profile including groups of the other profiles.

First, the assign profile process 260 is initialized at step 261, and performs similar functions as the initialization of the profile system 100 as described above. The initialization also includes the establishment of data values for particular data structures utilized in the assign profile process 260.

At step 262, the assign profile process 260 enables an administrator to select a user or group profile to be modified. At step 263 the assign profile process 260 enables an administrator to choose the category for user or group that was selected at step 262. At step 264, the assign profile process 260 enables the administrator to select existing profiles from a list. In the preferred embodiment, this list is displayed in the user interface, however, as known in the art there are other ways to implement this activity.

At step 265, the assign profile process 260 determines if there are more categories to be selected for the user or group selected at step 262. If it is determined at step 265 that there are more categories to be selected, the assign profile process 260 returns to repeat steps 263 through 265. If it is determined at step 265 that there are no additional categories to be assign, then the assign profile process 260 saves the profile being process that step 266.

At step 267 the assign profile process 260 determines if there are additional users or groups to be processed. If it is determined at step 267 that there are additional users or groups to be processed, the assign profile process 260 returns to repeat steps 262 through 267. However, if it is determined at step 267 that there are no additional users or groups to be processed then the assign profile process 260 exits at step 269.

Illustrated in FIG. 12 is a flow chart demonstrating an example of the operation of the establish priority process 280 utilized by the profile system 100 of the present invention, as shown in FIGS. 2A-3. An establish priority process 280 enables an administrator to assign priorities to existing profile settings.

First, the establish priority process 280 is initialized at step 281 and performs similar functions as the initialization of the profile system 100 as described above. The initialization also includes the establishment of data values for particular data structures utilized in the establish priority process 280.

At step 282, the establish priority process 280 indicates the priority order of existing groups. In the preferred embodiment, the priority order of the groups is indicated by utilizing a list in user interface. However, it is understood that other methods to indicate their priority are acceptable as well, including but not limited to indicating priority by numerical or alphabetic designators, hierarchical indicators, and the like. At step 283, the administrator is enabled to select a group that can be reassigned a group priority at step 284.

At step 285 it is determined if there are more groups with priority changes to be made. If it is determined to step 285 that there are more groups to be reassigned priorities, then the establish priority process 280 returns to repeat steps 283 through 285. However, if it is determined to step 285 that there are no other group priorities to change, the establish priority process 280 saves the priority order of the groups to database 12 at step 286. The establish priority process 280 then exits at step 289.

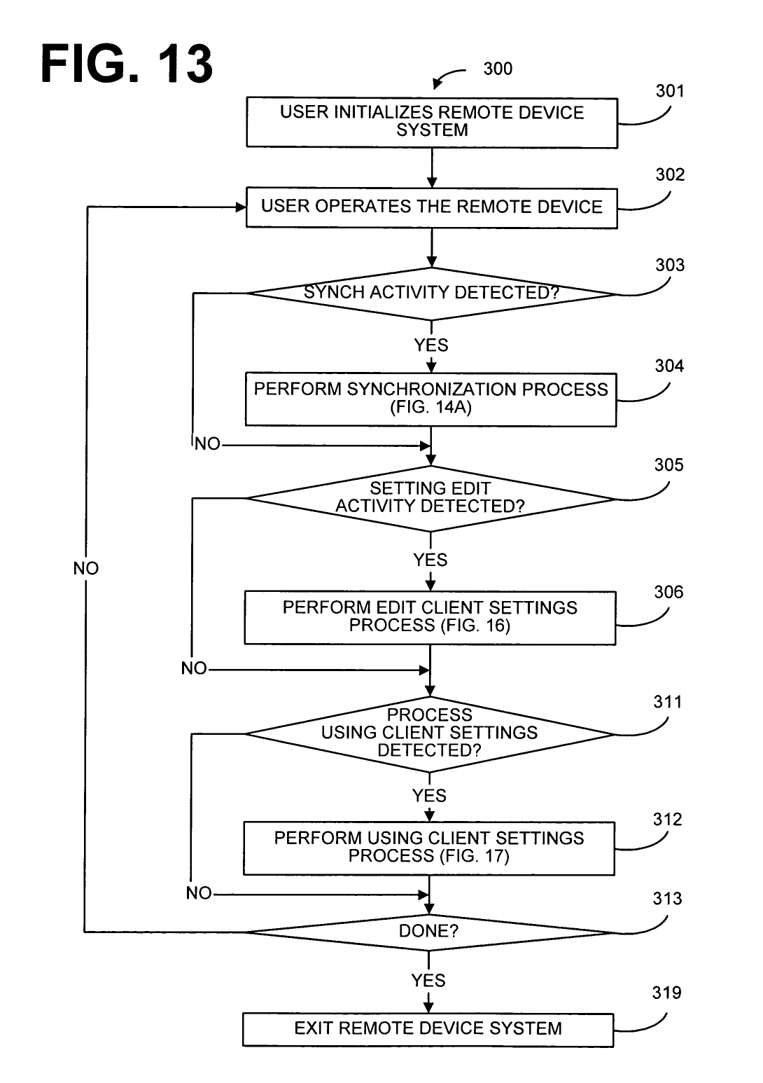

Illustrated in FIG. 13 is a flow chart demonstrating an example of the process flow 300 of the remote device 15, 17, 18 and 19 that utilizes the profile settings of the profile system 100 of the present invention, as shown in FIGS. 1-12. Hereinafter, the remote device is 15, 17, 18 and 19 will be referred to as remote device 15 for the sake of brevity. In the example illustrated, the profiles system 100 of the present invention will be demonstrated using the synchronization activity.

First, the remote device 15 is the initialized at step 301. This initialization includes the startup routines and processes embedded in the BIOS of the remote device 15. The initialization also includes the establishment of data values for particular data structures utilized in the remote device 15. At step 302, the user operates the remote device 15 in a normal operating mode.

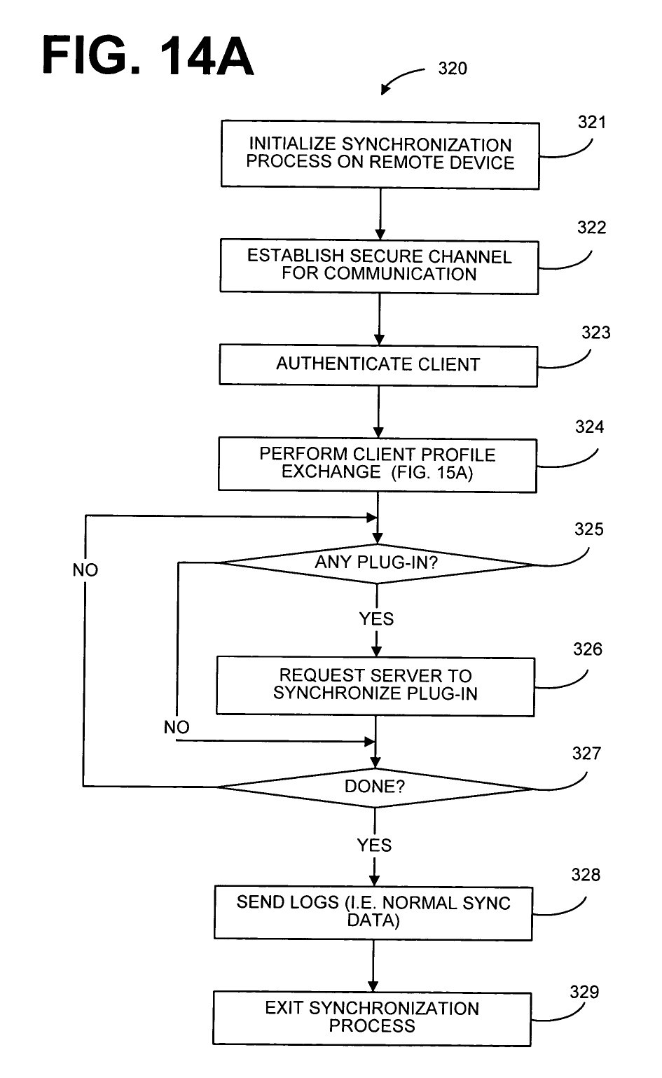

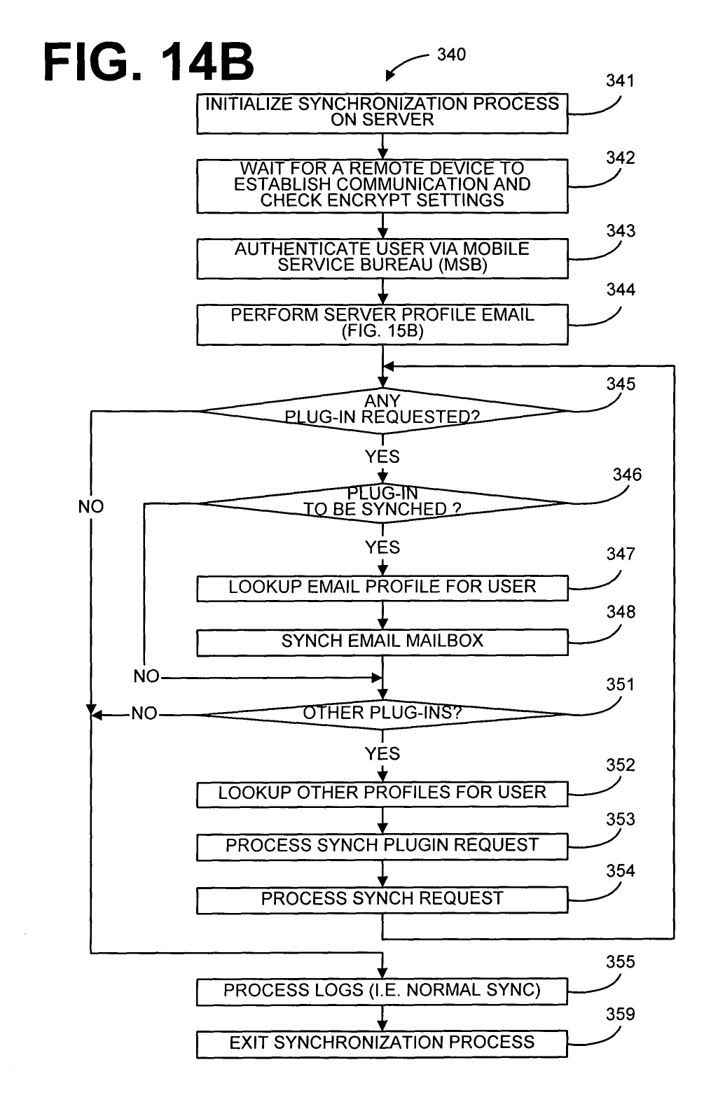

At step 303, it is determined if a synchronization activity indication is detected. It is determined at step 303 that a synchronization activity is not detected, then the process flow 300 then proceeds to step 305. However it is determined at step 303 that a synchronization activity has been detected, the synchronization process is performed at step 304. The synchronization process as herein defined in further detail with regard to FIG. 14.

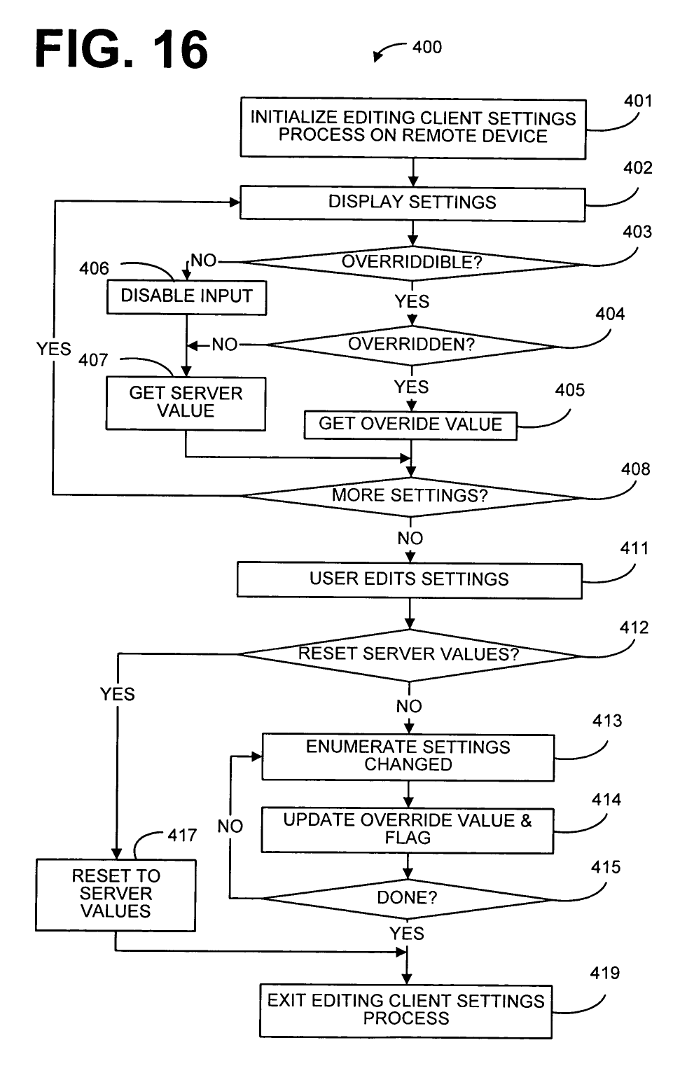

At step 305, it is determined if a setting edit activity is detected. If it is determined at step 305 that is setting edit activity is not detected, then the process flow 300 then proceeds to step 311. However, if it is determined at step 305 that a setting edit activity is detected, then the edit client settings process is performed at step 306. The edit client settings process as herein defined in further detail with regard to FIG. 16.

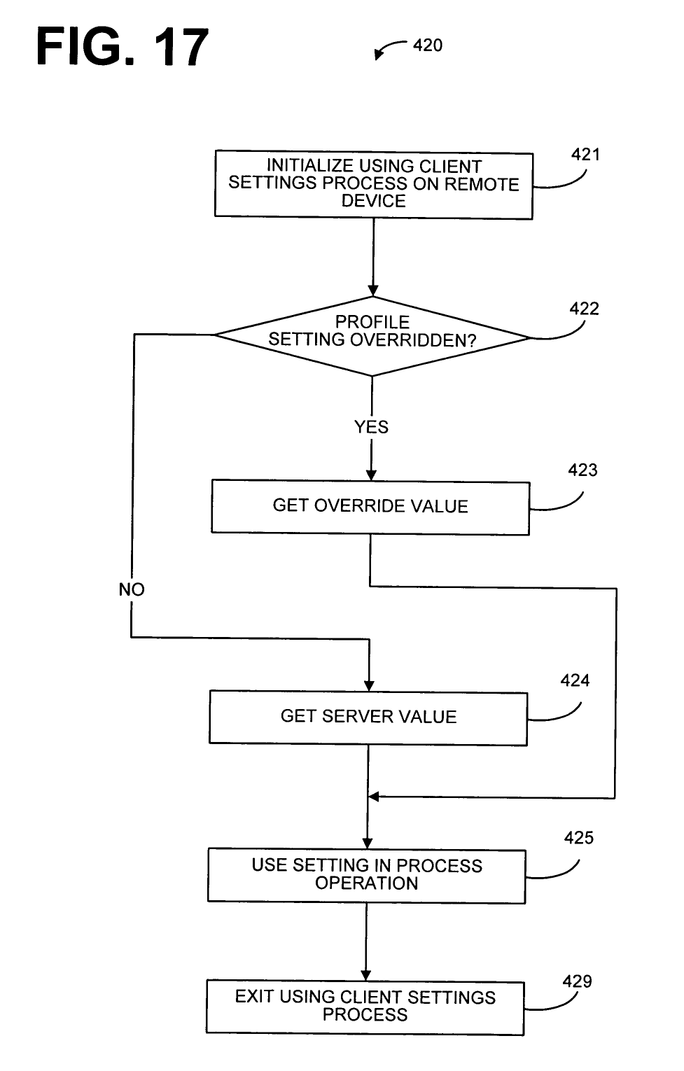

At step 311, it is determined if a process using client settings is detected. If it is determined at step 311 that a processed using client settings is not detected, then the process flow 300 then proceeds to step 313. However, if it is determined at step 311 that a processed using clients settings is detected, then the using client settings process is executed at step 312. An example of a generic process using client settings process as herein defined in further detail with regard to FIG. 17.

At step 313, the process flow 300 on the remote device determines if there is more processing to be done. If it is determined at step 313 that there is more processing to be done, the process flow 300 returns to repeat steps 302 through 313. However it is determined at step 313 that there is no further processing to be performed, then the process flow 300 then exits on the remote device 15 at step 319.

Illustrated in FIG. 14A is a flow chart demonstrating an example of the operation of the synchronization process 320 that operates on remote device 15 that utilizes the profile system 100 of the present invention, as shown in FIGS. 1-12. The illustrated example of the synchronization process 320 provides synchronization of data on the remote device 15 with data on server 11 (FIGS. 1, 2A and 2B). The data synchronized includes, but is not limited to a user's contacts, calendar, to do items, memos, personalized information data and the like on the remote device 15. Another example of the synchronization of information on a remote device 15 is described in U.S. patent application Ser. No. 10/037,626, filed on Jan. 3, 2002, entitled “A SYSTEM IN METHOD FOR DATA SYNCHRONIZATION BETWEEN REMOTE DEVICES” which is incorporated by reference herein in its entirety.

First, the synchronization process 320 is initialized at step 321, and performs similar functions as the initialization of the process flow 300 for the remote device 15 as described above. The initialization also includes the establishment of data values for particular data structures utilized in the synchronization process 320.

At step 322, the synchronization process 320 establishes a secure channel for communication with the server 11 (FIG. 2A). At step 323, the synchronization process 320 attempts to authenticate the client. This authentication is performed by passing credentials to the server, and the server verifying with required authentication systems. This authentication is to determine that the user attempting to connect is a valid user of the system.

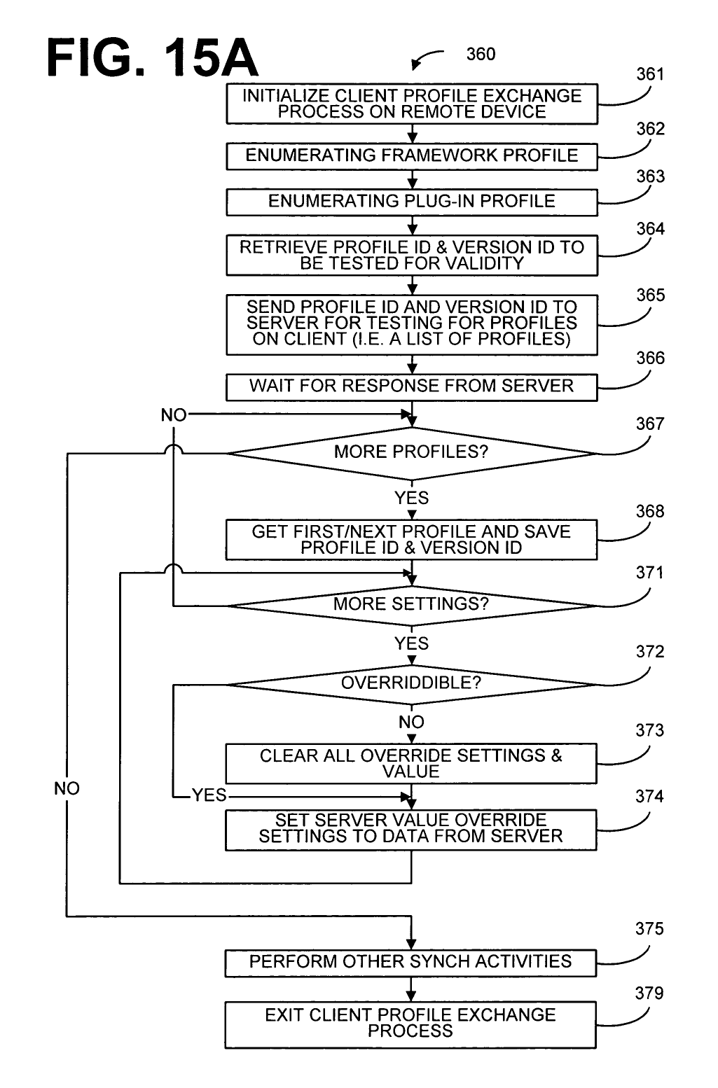

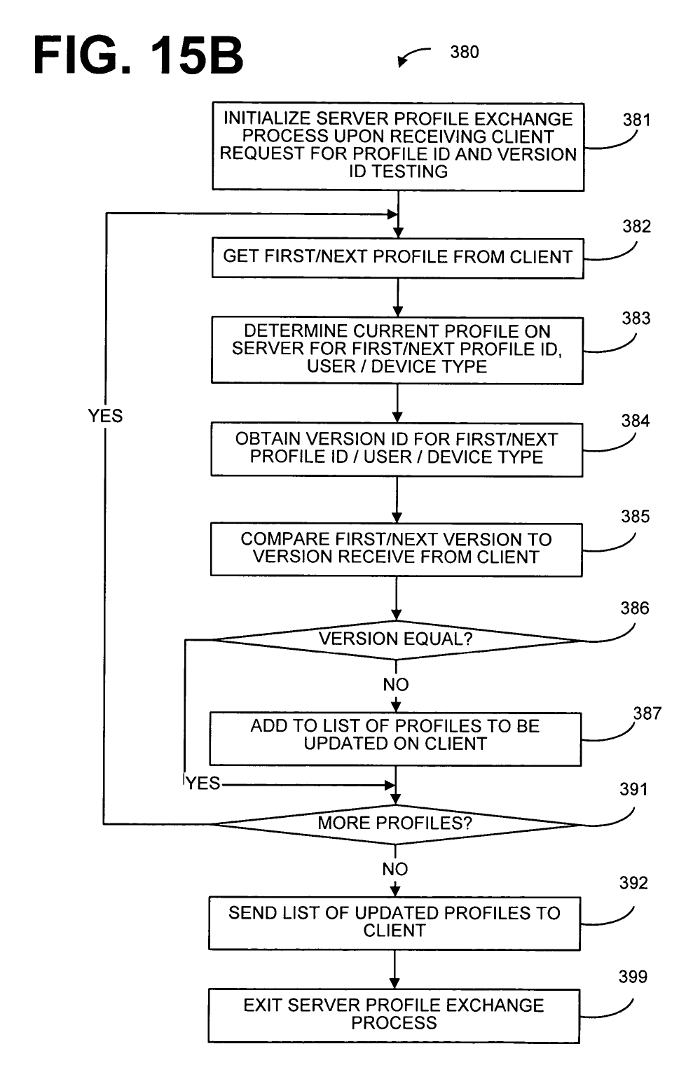

At step 324, the synchronization process 320 performs the client profile exchange process. The profile exchange process is performed prior to any synchronization activity in order to ensure compatibility between the remote device 15 and server 11 for the synchronization activity. The client profile exchange process as herein defined in further detail with regard to FIG. 15.

At step 325, it is determined if there are any plug-ins available for the synchronization process 320 discovered during the client profile exchange process performed at step 324. If it is determined to step 325 that there are no plug-ins discovered then the synchronized process 320 proceeds to step 327. However, if it is determined at step 325 that there are plug-ins currently installed on the remote device 15, then the synchronization of these plug-ins is performed at step 326.

At step 327, the synchronization process 320 determines if there are additional plug-ins to be synchronized. If there are additional plug-ins to be synchronized then the synchronization process 320 returns to repeat steps 325 through 327. However, if it is determined at step 327 that there are no additional plug-ins to be synchronized, then the synchronization process 320 performs the normal synchronization steps at step 328. The synchronization process 320 exits at step 329.

FIG. 14B is a flow chart illustrating an example of the operation of the server synchronization process 340 utilized by the profile system 100 of the present invention, as shown in FIGS. 2A-3. The illustrated example of the synchronization process 340 provides synchronization of data on the remote device 15 with data from server 11 (FIGS. 1, 2A and 2B). The data synchronized includes, but is not limited to a user's contacts, calendar, to do items, memos, personalized information data and the like on the remote device 15.

First, the server synchronization process 340 is initialized at step 341, and performs similar functions as the initialization of the profile system 100 as described above (FIG. 3). The initialization also includes the establishment of data values for particular data structures utilized in the server synchronization process 340.

At step 342, the server synchronization process 340 on server 11 waits for the remote device 15, 17, 18 and 19 (FIG. 2B) to establishes a secure channel for communication with the server 11 (FIG. 2A). At step 343, the server synchronization process 340 attempts to authenticate the user. This authentication is performed by the mobile service bureau.

At step 344, the synchronization process 340 performs the server profile exchange process. The server profile exchange process is performed prior to any synchronization activity in order to ensure compatibility between the remote device 15 and server 11 for the synchronization activity. The server profile exchange process as herein defined in further detail with regard to FIG. 15B.

At step 345, it is determined if there are any plug-ins requested from the synchronization process 340 by the client profile exchange process 320 (FIG. 14A). If it is determined to step 345 that there are no plug-ins requested then the synchronized process 340 proceeds to step 355. However, if it is determined at step 345 that there are plug-ins that were requested during the client profile exchange process 320, it is determined at step 346 if the plug-ins are to be synchronized. If it is determined at step 346 that the plug-ins are not to be synchronized then the server synchronization process 340 steps to step 351. However, if it is determined to step 346 that the plug-ins are to be synchronized, the server synchronization process 340 then performs a lookup of the email profile for the user at step 347. At step 348, the server synchronization process 340 synchronizes the e-mail mailbox.

At step 351, it is determined if there are other plug-ins to be processed. If it is determined at step 351 that there are no more plug-ins to be processed, the server synchronization process 340 then proceeds to step 355. However, if it is determined at step 351 that there are other plug-ins to the processed then a lookup for other profiles for the identified user is performed at step 352. At step 353, the plug-ins found are processed at step 354, the synchronization request is process and the server synchronization process 340 then returns to repeat step 345.

At step 355, the logs are processed like in the normal synchronization, and the synchronization process 340 on the server 11 then exits at step 359.

Illustrated in FIG. 15A is a flow chart demonstrating an example of the operation of the client profile exchange process 360 that that utilizes the profile system 100 of the present invention, as shown in FIGS. 1-14. The client profile exchange process 360 provides for the ability of the remote device 15 to communicate profile settings with the profile system 100 on server 11 (FIG. 2A). The client profile exchange process 360 establishes existing settings on remote device 15 and reconciles these with settings provided by the profile system 100 of the present invention on server 11. In addition, the client profile exchange process 360 enables a user to override settings received from server 11.

First, client profile exchange process 360 is initialized at step 361, and performs similar functions as the initialization of the process flow 300 for the remote device 15, as described above. The initialization also includes the establishment of data values for particular data structures utilized in the client profile exchange process 360.

At step 362 and 363 respectively, the framework and plug-ins profiles are documented for transmission to server 11. At step 364, the profile ID and version ID for each profile on the remote device 15 are retrieved in order to test their validity. At step 365, the client profile exchange process 360 sends the profile ID and version ID to the server for testing of the profiles existing on the remote device 15. The client of all exchange process 360 then waits at step 366 for response from the server 11.

Upon receiving a response from server 11, client profile exchange process 360 then determines if there more profile to be processed at step 367. If it is determined that there are no more files to be process, then the client profile exchange process 360 then proceeds to step 375 to perform other synchronization activities. However, if it is determined that there are more profile to be processed, the client profile exchange process 360 then obtained the first or next profile and saves the profile and version ID at step 368.

At step 371 to client profile exchange process 360 then determines if there are more settings to be process. If there are not more settings to be processed, the client profile exchange process 360 then returns to repeat step 367. However it is determined at step 371 that there are more settings to be processed then the client profile exchange process 360 determines if the settings are overriddible at step 372. If it is determined at step 372 to the current settings are overriddible, then the client profile exchange process 360 proceeds to step 374. However, if it is determined at step 372 to the settings received are not overriddible then the client profile exchange process 360 clears all the override settings and values for that particular setting in that particular profile. At step 374, the client profile exchange process 360 sets the server value override settings to the data (i.e. settings) received from the server 11 and returns to repeat step 371.

At step 375, the client profile exchange process 360 then performs all other synchronization activities and exits at step 315 when the synchronization activities are completed.

Illustrated in FIG. 15B is a flow chart demonstrating an example of the operation of the server profile exchange process 380 utilized by the profile system 100 of the present invention, as shown in FIGS. 2A-3. The server profile exchange process 380 provides for the ability of the profile system 100 on server 11 (FIG. 2A) to communicate profile settings with remote device 15 (FIG. 2B). The server profile exchange process 380 establishes existing settings provided by the profile system 100 of the present invention on server 11 for remote device 15, and reconciles these with settings received from remote device 15.

First, the server profile exchange process 380 is started upon receiving a client requests for profile ID and version ID testing. The server profile exchange process 380 is initialized at step 381, and performs similar functions as the initialization of the profile system 100 as described above. The initialization also includes the establishment of data values for particular data structures utilized in the server profile exchange process 380.

At step 382, the server profile exchange process 380 gets the first/next profile ID, user and device type from the remote device 15 (i.e. the client). At step 383, the current profile on server 11 is determined for the first/next profile ID, user and device type. At step 384, the server profile exchange process 380 obtains the version ID for the first/next profile ID, user and device type.

At step 385, a comparison is made of the first/next profile ID, user and device type received from the remote device 15 and the current profile on server 11 for first/next profile ID, user and device type. If it is determined that the versions are equal at step 386, then the server profile exchange process 380 proceeds to step 391. However it is determined at step 386 that the versions are not equal, then the server profile exchange process 380 adds the profile to the list of profiles to be updated on the client at step 387.

At step 391, the server profile exchange process 380 then determines if there are more profiles to be processed from the remote device 15. If it is determined that there are more profiles to be processed from those received from remote device 15, then the server profile exchange process 380 returns to repeat step 382 through 391. However, if it is determined at step 391 that there are no more profiles to be processed, then be server profile exchange process 380 sends a list of the values of the updated profiles to the remote device 15 (i.e. the client) at step 392 and exits at step 399.

Illustrated in FIG. 16 is a flow chart demonstrating an example of the operation of the editing client settings process 400 that that utilizes the profile system 100 of the present invention, as shown in FIGS. 1-12. The editing client settings process 400 enables a user to override profile settings provided by server 11 (FIG. 2A).

First, the editing client settings process 400 is initialized at step 401, and performs similar functions as the initialization of the remote device system 300 for the remote device 15 as described above. The initialization also includes the establishment of data values for particular data structures utilized in the editing client settings process 400.

At step 402, the settings received from server 11 are displayed. In the preferred embodiment the settings are displayed in a user interface. However, it is understood that there are numerous other known ways to display this information to a user. At step 403, it is determined if the current display setting is overriddible. If it is determined at step 403 that the current display setting is not overriddible, then the editing client settings process 400 proceeds to step 406.

However, if it is determined that the current setting displayed is overriddible, then it is determined if the current setting is overridden at step 404. If it is determined that the current setting is not overridden, the editing client settings process 400 proceeds to step 407. If it is determined that the current setting is overridden, then the editing client settings process 400 gets the override value at 405 and proceeds to step 408.

At step 406, the editing client settings process 400 disables the setting input. At step 407, the editing client settings process 400 gets the server value for the setting input.

At step 408, the editing client settings process 400 determines if there are more settings to be processed. If it is determined at step 408 that there are more settings to be processed, the editing client settings process 400 returns to repeat step 402 through 408. However, if it is determined at step 408 that there are no more settings to be processed, then the editing client settings process 400 enables a user to edit the settings at step 411.

At step 412, it is determined if the setting edited by the user needs to be reset to server values. If it is determined at step 412 that the settings should be reset to server values, the editing client settings process 400 resets the settings values to the values received from the profile system 100 on server 11 at step 417. The editing client settings process 400 then proceeds to exit at step 419.

However, if it is determined at step 412 that the setting should not be reset to the server values, the editing client settings process 400 evaluates the settings changed at step 413. At step 414, the override value and flag for the setting are updated. At step 415, it is determined if there are more user edited settings to be evaluated. It is determined to step 415 that there are more user settings to be evaluated then the editing client settings process 400 returns to repeat step 413 through 415. However, it is determined at step 415 that there are on no more settings to be evaluated then the editing client settings process 400 exits at step 419.

Illustrated in FIG. 17 is a flow chart demonstrating an example of the operation of the using client settings process 420 that utilizes the profile information from profile system 100 of the present invention, as shown in FIGS. 1-16. The using client settings process 420 is provided as an example of how all profile settings can be utilized.

First, the using client settings process 420 is initialized at step 421, and performs similar functions as the initialization of the remote device system 300 for the remote device 15, as described above. The initialization also includes the establishment of data values for particular data structures utilized in the using client settings process 420.

At step 422, it is determined if the profile settings are overridden. If it is determined at step 422 that of profile settings are overridden, the using client settings process gets the override values at step 423. However, if it is determined at step 42 that the profile settings are not overridden, then the using client settings process 420 gets the server value for the setting at step 424.

At step 425, the profile setting is used in process operation. After completing the process operation, the using client settings process 420 then exits at step 429.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A method for determining a set of settings used in an operation on a computer device, comprising the steps of:
determining the operation on the computer device;
determining the set of settings to perform the operation on the computer device; and
acquiring the set of setting to perform the operation on the computer device.

2. The method of claim 1, wherein said step of acquiring the set of settings further comprises the step of:
searching a database for the set of settings.

3. The method of claim 1, further comprising:
creating the set of settings in a database, further comprising the steps of:
selecting an existing set of settings;
copying the data in the existing set of settings into a location for the set of settings in the database; and
modifying the set of settings.

4. The method of claim 1, wherein said step of acquiring the set of settings further includes:
determining a second set of setting from a setting in the set of settings; and
acquiring the second set of setting to perform the operation on the computer device.

5. The method of claim 4, wherein said step of determining the second set of setting to perform the operation further comprises the step of:
determining a preference between multiple sets of settings when there is a conflict between the multiple sets of settings.

6. The method of claim 5, wherein said step of determining a preference between multiple sets further comprises the step of:
ordering the multiple sets of settings by priority.

7. The method of claim 1, wherein said step of determining the set of setting further comprises the step of:
determining an environment of the computer device.

8. The method of claim 1, wherein said step of determining the set of setting to perform the operation further comprises the step of:
determining the set of setting for a user.

9. The method of claim 8, wherein the user is a group of users.

10. The method of claim 1, wherein said step of determining the set of setting further comprises the step of:
determining an application setting for the operation on the computer device, wherein the application setting is selected from the group consisting of email, billing information, Personal Information Manager (PIM), personalized info, file delivery, systems management, software updates, websites, file backup, data sync applications, bandwidth management, authentication, encryption, Push Sync and ReadySync settings.

11. A system for determining set of settings used in an operation, comprising:
a computer device for performing the operation, the computer device comprising:
an operation module that determines an operation type;
a setting module that determines the set of setting to perform the operation on the computer device; and
an acquisition module that acquires the set of setting to perform the operation on the computer device.

12. The system of claim 1, further comprising:
a search module that searches a database for the set of settings.

13. The system of claim 11 further comprising:
a creation module that creates the set of settings in a database; the creation module further comprising:
a select module that selects an existing set of settings;
a copy module that copies the data in the existing set of settings into a location for the set of settings in the database; and
a modify module that modifies the set of settings.

14. The system of claim 11, further comprising:
a second determination module that determines a second set of setting from a setting in the set of settings; and
a second acquisition module that acquires the second set of setting to perform the operation on the computer device.

15. The system of claim 11, further comprising:
a preference module that determines a preference between multiple sets of settings when there is a conflict between the multiple sets of settings.

16. The system of claim 15, wherein the preference module further comprises:
an order module that orders the multiple sets of settings by priority.

17. The system of claim 11, further comprising:
an environment module that determines an environment of the computer device.

18. The system of claim 11, further comprising:
an application determination module that determines an application setting for the operation on the computer device, wherein the application setting is selected from the group consisting of email, billing information, Personal Information Manager (PIM), personalized info, file delivery, systems management, software updates, websites, file backup, data sync applications, bandwidth management, authentication, encryption, Push Sync and ReadySync settings.

19. The system of claim 11, further comprising:
a user determination module that determines the set of setting for a user.

20. The system of claim 19, wherein said user is a group of users.

21. A computer readable medium for a logic that determines set of settings used in an operation on a computer device, comprising:
logic for determining the operation on the computer device;
logic for determining the set of setting to perform the operation on the computer device; and
logic for acquiring the set of setting to perform the operation on the computer device.

22. The computer readable medium of claim 21, wherein the logic for acquiring further comprises:
logic for searching a database for the set of settings.

23. The computer readable medium of claim 21, further comprising:
logic for creating the set of settings in a database, further comprising:
logic for selecting an existing set of settings;
logic for copying the data in the existing set of settings into a location for the set of settings in the database; and
logic for modifying the set of settings.

24. The computer readable medium of claim 21, further comprising:
logic for determining a second set of setting from a setting in the set of settings; and
logic for acquiring the second set of setting to perform the operation on the computer device.

25. The computer readable medium of claim 21, further comprising:
logic for determining a preference between multiple sets of settings when there is a conflict between the multiple sets of settings.

26. The computer readable medium of claim 21, further comprising:
logic for searching a database for the set of settings.

27. The computer readable medium of claim 21, further comprising:
logic for determining an environment of the computer device.

28. The computer readable medium of claim 21, further comprising:
logic for determining an application setting for the operation on the computer device, wherein the application setting is selected from the group consisting of email, billing information, Personal Information Manager (PIM), personalized info, file delivery, systems management, software updates, websites, file backup, data sync applications, bandwidth management, authentication, encryption, Push Sync and ReadySync settings.

29. The computer readable medium of claim 21, further comprising:
logic for determining the set of setting for a user.

30. The computer readable medium of claim 21, wherein said user is a group of users.

31. A system for determining set of settings used in an operation on a computer device, comprising:
means for logic for determining the operation on the computer device;
logic for determining the set of setting to perform the operation on the computer device; and
logic for acquiring the set of setting to perform the operation on the computer device.

32. The system of claim 31, further comprising:
means for searching a database for the set of settings.

33. The system of claim 31, further comprising:
means for logic for creating the set of settings in a database, further comprising:
logic for selecting an existing set of settings;
logic for copying the data in the existing set of settings into a location for the set of settings in the database; and
logic for modifying the set of settings.

34. The system of claim 31, further comprising:
means for logic for determining a second set of setting from a setting in the set of settings; and
logic for acquiring the second set of setting to perform the operation on the computer device.

35. The system of claim 31, further comprising:
means for determining a preference between multiple sets of settings when there is a conflict between the multiple sets of settings.

36. The system of claim 31, further comprising:
means for ordering the multiple sets of settings by priority.

37. The system of claim 31, further comprising:
means for determining an environment of the computer device.

38. The system of claim 31, further comprising:
means for determining an application setting for the operation on the computer device, wherein the application setting is selected from the group consisting of email, billing information, Personal Information Manager (PIM), personalized info, file delivery, systems management, software updates, websites, file backup, data sync applications, bandwidth management, authentication, encryption, Push Sync and ReadySync settings.

39. The system of claim 31, further comprising:
means for logic for determining the set of setting for a user.

40. The system of claim 31, wherein said user is a group of users.
